(19) United States
(12) Patent Application Publication
(10) Pub. No.: US 2025/0031725 A1
(43) Pub. Date: Jan. 30, 2025

(54) EDIBLE PET CHEW

(71) Applicant: Shanghai Sunlight Innov Trading Co., Ltd., Shanghai (CN)

(72) Inventors: Dequan Shen, Shanghai (CN); Guangqiang Xu, Shanghai (CN)

(21) Appl. No.: 18/914,083

(22) Filed: Oct. 12, 2024

Related U.S. Application Data
(63) Continuation-in-part of application No. 17/818,353, filed on Aug. 8, 2022.

(51) Int. Cl. A23K 20/147; A23K 10/20; A23K 10/30; A23K 40/25; A23K 50/40

(52) U.S. Cl. CPC A23K 20/147; A23K 10/20; A23K 10/30; A23K 40/25; A23K 50/40

(57) ABSTRACT

A pet chew includes a finned tubular component formed of a collagen-based material, a beef skin corium-based material, a plant-based material, a meat-based material etc. The finned tubular component includes a fin and a tube body part, wherein the fin extends on a surface of the tube body part along a length of the tube body part. The finned tubular component is made of a composition material and is formed by extrusion process.

### CROSS-REFERENCE TO RELATED APPLICATIONS

This is a Continuation-In-Part application that claims the benefit of priority under 35U.S.C. § 120 to a non-provisional application, application Ser. No. 17/818,353, filed on Aug. 8, 2022, which is a non-provisional application that claims the benefit of foreign priority to Chinese Patent Application No. 202210729420.8, filed on Jun. 24, 2022, the entire contents of which are hereby incorporated by reference in their entirety.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### FIELD OF DISCLOSURE

The field of this disclosure relates to an edible pet chew.

### DESCRIPTION OF RELATED ARTS

Dogs as carnivorous animals have inherent urge to chew things. Visiting a pet store or supermarket makes it readily apparent that there is a wide selection of dog chew products created to accommodate their chewing activities. These products of this kind provide favorable benefits to dogs such as entertaining, exercising jaws, reducing plaque and tartar, freshening breath and keeping them busy. “Pet chews” are intended to be chewed by a pet/dog for an extended period of time and then swallowed. A variety of pet chews have been developed to help satisfy the chewing needs of animals. Traditional rawhide chews and later plant-based (starch-based) chews made of (artificial) composition material such as vegetable toothbrush-shaped dental chews (under Greenies brand) were introduced to market widely welcome by dogs and their owners. Plant-based dog bones under SmartBones™ brand and other similarly-formulated tube-element bones have been also introduced to the market in order to substitute some traditional rawhide chews with success. In the chew industry, extruded sheet chew and extruded (traditional) tube chew stay distinct from each other and run distinctly.

The EPO application No. EP16187720.4 by Qiu, filed on Sep. 7, 2016, disclosed a chew made of a traditional tube chew. The U.S. application Ser. No. 15/799,313 by Chen, filed on Oct. 31, 2017, disclosed a chew made of a traditional hollow tube chew. The U.S. application Ser. No. 16/718,149 by the present inventor(s), filed on Dec. 17, 2019, disclosed a chew having a first member of traditional tube member and a second member of meat alternative. The EPO application No. EP21151881.6 by the present inventor(s), filed on Jan. 15, 2021, disclosed a chew having a first member of traditional tube member and a second member of porous member.

Pet chews have also been developed that may provide valuable vitamins and nutrients to pets, augmenting healthy feeding regimes. It is noted that dog treats and dog chews may usually refer to dry feeding stuffs (dry feed) rather than moist feed (wet treat or wet feed), with moisture content substantially less than 25%.

### SUMMARY OF THE PRESENT DISCLOSURE

In some embodiments of the present disclosure, it is to provide an edible pet chew (pet treat) including a component formed from an extrudate produced by extrusion process. The extrusion process may typically be hot-melt-extrusion (HME) process, while alternatively, the extrusion process may be cold extrusion process.

In some embodiments of the present disclosure, it is to provide an edible pet chew (pet treat) free of rawhide. The presence of rawhide or rawhide sheet ingredient (either in original sheet form or ground form) in a pet chew or particularly in a component of a chew may bring the following drawbacks to the chew: A), Rawhide material does not have inherently-attractive flavor urging dogs to chew, which may not be helpful to the chew attraction. B), Manufacture of rawhide is a relatively unregulated industry. It may create pollution to the environment. C), The residues of chemicals such as NH₄CL, H₂O₂ and NaOH that are usually used in rawhide manufacture especially in an unregulated way may bring health jeopardy to dogs. D), Heavy metals may remain in finished products made of rawhide, which may harm dogs' health. E), Rawhide may not be easily digestible and end up causing unnecessary digestive discomfort.

In some embodiments of the present disclosure, it is to provide a pet chew (pet treat) including a finned tubular component (tubular component with a fin part), or an extruded sheet component, or an extruded (traditional) tube component, in which the component is made of a composition material. Preferably, the aforementioned component made of the composition material is formulated or processed in a way so as to provide elasticity for improving chewing texture and durability or provide toughness or strength for improving durability for longer chewing activities to it in final product. Preferably, the durability or strength to endure dog's chewing activity of the pet chew is primarily provided by the aforementioned component.

In some embodiments of the present disclosure, it is to provide a pet chew (pet treat) made of a composition material that is free of rawhide.

In some embodiments of the present disclosure, it is to provide an edible pet chew (pet treat) having a component formed from an extrudate made of a composition material. In at least one embodiment of these, the composition material is a thermoplastic one.

In an embodiment of the present disclosure, it is to provide an edible pet chew (pet treat) including a tubular component with a fin part (it may also be referred to as a finned tubular component), or an extruded sheet component, or an extruded (ordinary) tube component made of a (artificial) composition material, where the component in composition has a naturally occurring animal material (or a natural Animal Parts material, or a natural organ material) that inherently/naturally contains at least 50% collagen, such as animal cartilage, trachea, animal car, poultry foot, esophagus, shark cartilage, animal pizzle, ligament, pericardium and tendon (these Natural Animal Part materials are considered as a sort of naturally-collagen-rich materials), providing improved digestibility, reduced joint pain, reduced inflammation and joint health benefits to dogs. Animal cartilage, trachea, animal car, poultry foot, esophagus, shark cartilage, animal pizzle, ligament, pericardium and tendon and other similar Natural Animal Part materials as naturally-collagen-rich ones can provide natural source of collagen to the pet chews. Also, considerable proportion of collagen constituent in the component composition may provide elasticity for improving chewing texture (durability) or toughness (strength) for improving durability for longer chewing activities to it in final product.

In some embodiments of the present disclosure, it is to provide a pet chew (pet treat) whose first ingredient (or number one proportion ingredient) by weight in the composition of the final end product is collagen, in which the pet chew includes a tubular component with a fin part (finned tubular component), or an extruded sheet component, or an extruded tube component. In the present disclosure, when a material or ingredient is referred to as “first ingredient” or “number one proportion ingredient” in a specific formula or composition, it follows the rule that all the ingredients in the formula (composition) is listed in descending order of predominance by weight.

In some embodiments of the present disclosure, it is to provide a pet chew (pet treat) including a tubular component with a fin part (finned tubular component), or an extruded sheet component, or an extruded (ordinary) tube component, in which the component is formed of a collagen-based composition material having a collagen constituent (ingredient) as the first ingredient (or number one proportion ingredient) by weight in its composition.

In some embodiments of the present disclosure, it is to provide a pet chew (pet treat) including a tubular component with a fin part (finned tubular component), or an extruded sheet component, or an extruded ordinary tube component, in which the component is formed of a collagen-based composition material having at least 20% (typically at least 25%, more typically at least 30%) material of corium layer of animal hide (ground form) as the first ingredient (or number one proportion ingredient) by weight in its composition.

In some embodiments of the present disclosure, it is to provide a pet chew (pet treat) including a tubular component with a fin part (finned tubular component), or an extruded sheet component, or an extruded (ordinary) tube component, in which the component is formed of a collagen-based composition material having at least 25% cartilage material (esp. in ground form) as the first ingredient (or number one proportion ingredient) by weight in its composition.

In some embodiments of the present disclosure, it is to provide a pet chew (pet treat) including a tubular component with a fin part (finned tubular component), or an extruded sheet component, or an extruded (ordinary) tube component, in which the pet chew is a cartilage-based chew as a whole contains at least 25% cartilage constituent (or element, or ingredient) in final end product counting in the cartilage(s) present in every component(s).

In some embodiments of the present disclosure, it is to provide a pet chew (pet treat) including a tubular component with a fin part (finned tubular component), or an extruded sheet component, or an extruded (ordinary) tube component, in which the component is formed of a composition including any one of: at least 3% by weight meat by-product ingredient(s) that is naturally collagen-rich, at least 3% by weight meat by-product ingredient(s) that is naturally cartilage-rich, at least 3% by weight meat by-product ingredient(s) that is naturally Glucosamine (Chondroitin)-rich and a combination thereof.

In an embodiment of the present disclosure, it is to provide an edible pet chew (pet treat) including a tubular component with a fin part (or also be referred to as a finned tubular component), or an extruded sheet component, or an extruded (ordinary) tube component made of a (artificial) composition material, being fairly dural for chewing activities, which can endure a dog's long-time chewing before being swallowed.

In some embodiments of the present disclosure, it is to provide an edible pet chew (pet treat) including an ordinary tubular component (or a finned tubular component that is not an ordinary tubular component) made of a (artificial) composition material, which is a hollow object. The hollow structure of the tubular component may allow consumers to fill additional edible materials or treats into it, both of which are jointly served to their dogs, or may accept additional edible material filling (stuffing) component before obtaining finished products.

In some embodiments of the present disclosure, a pet chew (pet treat) is provided including a first component (finned tubular component, or extruded sheet component, or extruded tubular component) and a second component (an additional edible material). In an embodiment, the second component is wrapped or surrounded in by the first component. In an embodiment, the second component is a porous material (typically formed from a plant-based material or a collagen-based material) wrapped in the first component. In an embodiment, the second component wraps or surrounds the first component. In an embodiment, the second component and the first component are assembled in a relationship that the first and second component form alternating layers in that assembly. In some embodiments, the second material is a naturally-collagen-rich material, such as porcine tendon, turkey cartilage, beef trachea and corium layer of animal skin.

In one aspect of the present disclosure, an edible pet chew (pet treat) is provided including an extruded tubular (or tube-shaped) component (or also be referred to as a finned tubular component, finned tube component) having a (main) tube body part and a “fin” part on the surface of the tube body part, formed form a finned tubular extrudate. The finned tubular component may be formed by a mono-extrusion or a co-extrusion process creating the main tube part and the fin part together simultaneously.

In some embodiments of the present disclosure, it is to provide an edible pet chew (pet treat) including an extruded plant-based tubular (or tube-shaped) component (or also be referred to as a finned tubular component) having a (main) tube body part and a fin part on the surface, in which the plant-based finned tubular component is made of a plant-based composite/composition having at least 50% plant ingredient.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the finned tubular component is made of a composition having 10%-30% meat ingredient, 20%-50% plant ingredient and a chemical. In some embodiments of the present disclosure, it is to provide an edible pet chew including an extruded meat-based tubular (or tube-shaped) component (or also be referred to as a finned tubular component) having a (main) tube body part and a fin part on the surface, in which the meat-based finned tubular component is made of a meat-based composition having 30%-99% meat (or meat by-product, or a combination of meat and meat by-product) ingredient, 20%-50% plant ingredient and a chemical.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the pet chew as a collagen-based chew as a whole contains at least 25% collagen constituent (or element, or ingredient) in final end product counting in the collagen present in every component(s).

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is formed of a collagen-based composition material having at least 20% collagen-rich (naturally-collagen-rich) material by weight and/or at least 10% collagen (constituent, element or ingredient) by weight.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is formed of a collagen-based composition material having at least 25% (more typically at least 30%) collagen (constituent, element or ingredient) by weight in final product.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is formed of a collagen-based composition material having at least 10% meat ingredient by weight and any one of: at least 20% naturally-collagen-rich material by weight, at least 10% collagen (constituent, element or ingredient) by weight and a combination thereof.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is formed of a collagen-based composition material having at least 10% meat ingredient by weight and any one of: at least 30% naturally-collagen-rich material by weight, at least 10% collagen (constituent, element or ingredient) by weight and a combination thereof. In some embodiments of the present disclosure, it is to provide an edible pet chew including an extruded finned tubular component formed of a collagen-based composition material having at least 30% meat ingredient by weight and any one of: at least 30% naturally-collagen-rich material by weight, at least 10% collagen (constituent, element, or ingredient) by weight and a combination thereof.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is formed of a collagen-based composition material having at least 10% meat ingredient by weight, at least 20% plant ingredient by weight and any one of: at least 20% naturally-collagen-rich material by weight, at least 10% collagen (constituent, element or ingredient) by weight and a combination thereof.

In some embodiments of the present disclosure, it is to provide an edible pet chew (pet treat) including an extruded tubular (or tube-shaped) component (or also be referred to as a finned tubular component) having a (main) tube body part and a fin part on the surface, in which the extruded finned tubular component is made of a collagen-based composition material having at least 20% plant ingredient by weight and any one of: at least 20% naturally-collagen-rich material by weight, at least 10% collagen (constituent, element or ingredient) by weight and a combination thereof. In at least one embodiment of the aforementioned ones, the finned tubular component is made of a collagen-based composition material having 20%-50% plant ingredient by weight and any one of: at least 50% naturally-collagen-rich material by weight, at least 25% collagen (constituent, element, or ingredient) by weight and a combination thereof.

In another aspect of the present disclosure, an edible pet chew (pet treat) is provided including an extruded sheet component (formed form a sheet extrudate) formed of a collagen-based composite/composition material having at least 50% naturally-collagen-rich (or collagen-rich) material by weight and/or at least 30% collagen (constituent, element, or ingredient) by weight.

In some embodiments of the present disclosure, it is to provide an edible pet chew (pet treat) including an extruded sheet component made of a collagen-based composition material having at least 10% meat ingredient by weight and any one of: at least 50% naturally-collagen-rich material by weight, at least 30% collagen (constituent, element, or ingredient) by weight and a combination thereof. In some embodiments of the present disclosure, it is to provide an edible pet chew including an extruded sheet component made of a collagen-based composition material having at least 30% meat ingredient by weight and any one of: at least 50% naturally-collagen-rich material by weight, at least 30% collagen (constituent, element, or ingredient) by weight and a combination thereof. In at least one embodiment of these aforementioned, the naturally-collagen-rich material is a naturally occurring animal material (or a natural Animal Parts material, or a natural organ material) that inherently/naturally contains at least 50% collagen.

In some embodiments of the present disclosure, it is to provide an edible pet chew (pet treat) including an extruded sheet component made of a collagen-based composition material having at least 20% plant ingredient by weight and any one of: at least 50% naturally-collagen-rich material by weight, at least 30% collagen (constituent, element, or ingredient) by weight and a combination thereof.

In yet another aspect of the present disclosure, an edible pet chew (pet treat) is provided including an extruded (ordinary) tubular component (formed from a tubular extrudate) formed of a collagen-based composite/composition material having at least 20% collagen-rich (naturally-collagen-rich) material by weight and/or at least 10% collagen (constituent, element, or ingredient) by weight. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal car, poultry foot, esophagus, animal pizzle, ligament, pericardium, animal tendon, eggshell membrane, and any combination thereof.

In some embodiments of the present disclosure, it is to provide an edible pet chew (pet treat) including an extruded tubular component formed of a collagen-based composition material having at least 20% collagen-rich (naturally-collagen-rich) material by weight and/or at least 10% collagen (constituent, element or ingredient) by weight, in which the pet chew as a collagen-based chew as a whole contains at least 25% collagen constituent (or element, or ingredient) in final end product counting in the collagen present in every component(s). In some embodiments of the present disclosure, the pet chew as a collagen-based chew as a whole contains at least 50% collagen constituent (or element, or ingredient) by weight in final end product counting in the collagen present in every component(s), where collagen constituent may occupy the majority proportion by weight in the chew.

In some embodiments of the present disclosure, it is to provide an edible pet chew (pet treat) including an extruded tubular component formed of a collagen-based composition material having at least 25% (more typically at least 30%) collagen (constituent, element, or ingredient) by weight in final product.

In some embodiments of the present disclosure, it is to provide an edible pet chew (pet treat) including an extruded tubular component formed of a collagen-based composition material having at least 10% meat ingredient by weight and any one of: at least 20% naturally-collagen-rich material by weight, at least 10% collagen (constituent, element, or ingredient) by weight and a combination thereof.

In some embodiments of the present disclosure, it is to provide an edible pet chew (pet treat) including an extruded tubular component formed of a collagen-based composition material having at least 10% meat ingredient by weight and any one of: at least 30% naturally-collagen-rich material by weight, at least 10% collagen (constituent, element, or ingredient) by weight and a combination thereof. In some embodiments of the present disclosure, it is to provide an edible pet chew including an extruded tubular component formed of a collagen-based composition material having at least 30% meat ingredient by weight and any one of: at least 30% naturally-collagen-rich material by weight, at least 10% collagen (constituent, element, or ingredient) by weight and a combination thereof.

In some embodiments of the present disclosure, it is to provide an edible pet chew (pet treat) including an extruded tubular component formed of a collagen-based composition material having at least 20% plant ingredient by weight and any one of: at least 20% naturally-collagen-rich material by weight, at least 10% collagen (constituent, element, or ingredient) by weight and a combination thereof. In at least one embodiment of the aforementioned ones, the extruded tubular component is formed of a collagen-based composition material having 20%-50% plant ingredient by weight and any one of: at least 50% naturally-collagen-rich material by weight, at least 25% collagen (constituent, element, or ingredient) by weight and a combination thereof.

In some embodiments of the present disclosure, it is to provide an edible pet chew (pet treat) including an extruded tubular component, in which the extruded tubular component is made of a composition having 10%-30% meat ingredient and 20%-50% plant ingredient, and optionally 2%-35% humectant (more typically 10%-25% humectants; humectants such as glycerin, sorbitol) ingredients. In some embodiments of the present disclosure, it is to provide an edible pet chew including a meat-based extruded tubular component, in which the meat-based tubular component is made of a meat-based composition having 30%-99% meat (or meat by-product, or a combination of meat and meat by-product) ingredient and 20%-50% plant ingredient, and optionally 2%-35% humectant (more typically 10%-25% humectants; humectants such as glycerin, sorbitol) ingredients.

These embodiments of the present disclosure will become apparent from the following detailed description, the accompanying drawings, and the appended claims.

### BRIEF DESCRIPTION OF THE DRAWINGS

FIG. 1 is a view of a pet chew according to an embodiment of the present disclosure in a knotted bone shape with a finned tubular component and other components.

FIG. 2 illustrates views of a finned tubular extrudate according to an embodiment of the present disclosure in comparison to a rolled sheet cylinder and their corresponding cross-sections.

FIG. 3 is a view of a pet chew according to an embodiment of the present disclosure in a twisted stick shape with a finned tubular component.

FIG. 4 shows some charts illustrating a group of exemplary finned tubular extrudates produced by different extruder die designs to make pet chews according to embodiments the present disclosure.

FIG. 5 shows a view of a pet chew according to an embodiment of the present disclosure in a hollow cylinder shape with a finned tubular component, in conjunction with its cross-section view and a view of extruder die for manufacture.

FIG. 6 is a view of a pet chew according to an embodiment of the present disclosure in a bow tie shape with a finned tubular component and another, in conjunction with its cross-section view.

FIG. 7 is a view of an extruded sheet (a part) according to an embodiment of the present disclosure, which may work as a basic element to be formed into a chew product component.

FIG. 8 shows several cross-section views of a group of exemplary “extruded sheet component” extrudates according to embodiments of the present disclosure, produced by various extruder die designs.

FIG. 9 is a view of a pet chew in shape of knotted bone according to an embodiment of the present disclosure, formed from a collagen-based extruded sheet extrudate.

FIG. 10 is a view of a pet chew in shape of bow tie according to an embodiment of the present disclosure, formed from a collagen-based extruded sheet extrudate.

FIG. 11 is a view of a pet chew in shape of ball according to an embodiment of the present disclosure formed from several pieces of collagen-based extruded sheets.

FIG. 12 is a view of a pet chew in shape of knotted bone according to an embodiment of the present disclosure including a piece of collagen-based extruded sheet with three pieces of meat-based strips wrapped in.

FIG. 13 is a view of a pet chew in shape of twisted stick according to an embodiment of the present disclosure including a piece of collagen-based extruded sheet with a pieces of chicken strip wrapped on the surface.

FIG. 14 is a pet chew in shape of hollow cylinder according to an embodiment of the present disclosure composed of an extruded tubular component.

FIG. 15 illustrates cross-section views of a group of exemplary “extruded tubular component” extrudates according to embodiments of the present disclosure, being produced by various extruder die designs.

FIG. 16 shows a pet chew in shape of twisted cylinder according to an embodiment of the present disclosure formed of an extruded tubular component, together with a view of cross-section hereof.

FIG. 17 is a view of a pet chew in cylindrical shape according to an embodiment in the aforementioned aspect of the present disclosure, being formed from an extruded tubular component extrudate.

FIG. 18 shows a pet chew in shape of knotted bone as an embodiment of the present disclosure formed of an extruded tubular component and an oval-shaped cylindrical core component wrapped therein.

FIG. 19 is view of various layers of a beef skin.

FIG. 20 is a prior art, illustrating an example of a common mono-extrusion process and another of a common co-extrusion one.

FIG. 21 shows a pet chew in shape of tube according to an embodiment of the present disclosure formed of a tubular component with a series of alternating ridges and grooves on surface, together with a view of cross-section hereof.

### DETAILED DESCRIPTION OF THE DISCLOSURE

Embodiments are provided in the following description only as examples. The general principles defined in the following description would be applied to other embodiments, alternatives, modifications, equivalents, and applications without departing from the spirit and scope of the present disclosure.

The term “component” in the present disclosure may be defined as a constituent part or aspect of something more complex (e.g., a component of a pet chew). Typically, the term of “component” (e.g. the extruded collagen-based finned tubular component) in the present disclosure may refer to a separate component (or member) in final end product of a pet chew being separate or distinct from other component(s), member(s) or part(s), in which the separate component (or member) may be usually manually separable from other component(s), member(s) or part(s) by hand.

Collagen is an essential protein for dogs, found in various parts of their body, and its loss with age may lead to health issues such as arthritis, coat and skin problems, and digestive issues. A common recommendation is to give approximately 1 to 2 grams of collagen per 10 pounds of body weight. Many dog owners find it is a challenge to give collagen supplements to their dogs by feeding them a capsule or a pill-like treat containing the supplements whereas a diet with collagen goes easier. Adding collagen to a dog's diet can provide many benefits such as pain and arthritis relief, a healthy coat, improved skin health, joint and bone health, improved digestion, or digestibility, reduced joint pain, reduced inflammation, support for post-operation recovery and increased appetite. On the market, a bunch of natural collagen sheet chews that are made of an innermost layer of beef skin in their naturally-occurring sheet form (without undertaking grounding process or another to destroy its natural form) have been introduced to offer the collagen benefits to dogs. These natural collagen sheet chew products suffer with some drawbacks as follows. Manufacturing a quality natural collagen sheet chew (such as a mini-sized knot bone) involves preparation of natural collagen sheet material which need comply with particular pre-determined raw material quality standards such as standards for the size, thickness and unevenness of collagen sheet raw material, which may result in a comparatively expensive raw material. And the manufacturing practices, especially the trimming process to prepare rectangular-shaped collagen sheet raw materials, may create lots of collagen sheet piece leftovers. Though natural collagen sheet may perform better than rawhide in health aspect, natural collagen sheet still to some extent suffers with digestibility and attraction issue, and is considered unsafe for dogs in a jeopardy of getting choked or hurt by sharp edges while gnawing on. On the market, a kind of plant-based sheet chews can also be found to replace traditional rawhide chews.

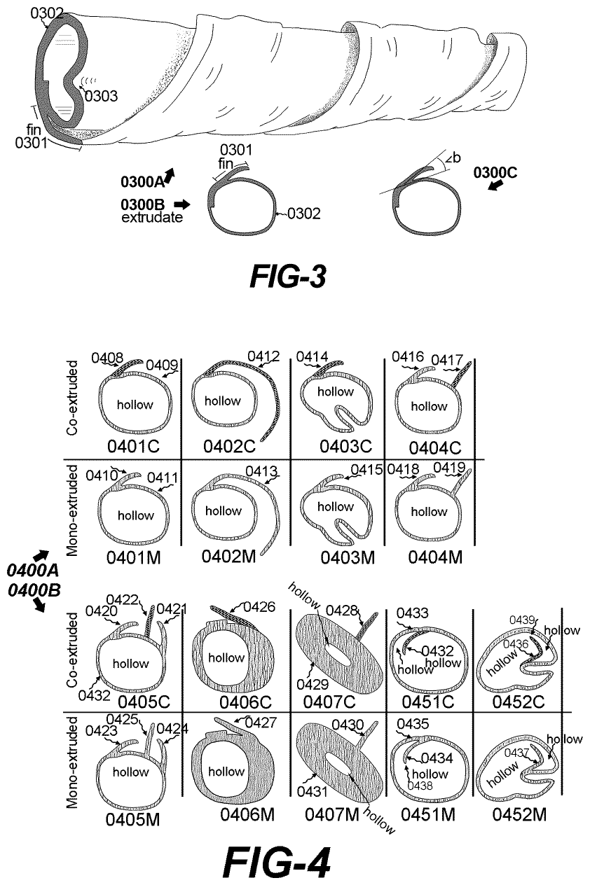

The term of “fin” in the present disclosure, for example the “fin” from the phrase of “tubular component with fin”, “tubular extrudate with fin”, “finned tubular component” or “finned tubular extrudate”, generally refers to a projecting thin piece sticking out (or extending) from the main body of the tubular object/component/extrudate and extending or running (longitudinally) along the length of the main body; there is a space or distance between the extreme edge (the edge far from the surface of the tubular object) of the projecting thin piece and the main tube body, or in other words, the extreme edge of the projecting thin piece is free from the tube body object. Preferably, the “fin” part and the main tube body part are integrally formed (the fin and the main tube body together form one) by extrusion process and may usually together form a single piece or one piece (the two parts are not separate). Typically, in a finned tubular component/extrudate (or tubular component/extrudate with a fin), one extremity of the width of a fin is attached to a surface of the tube body and the opposite extremity is a free end (spaced from the surface of the main tuber body). A “fin” is typically in a thin and curved form (“curved” herein refers to an object whose cross-section is a curve), while it could be in a thin and flat form instead in some other embodiments. Typically, a “fin” of this term is a sheet-like part (resembling a sheet in shape or appearance) sticking out from the main tube body of the tubular object/component/extrudate. Typically, a “fin” sticks out at a slant from the main tube body. In geometry, in a finned tubular extrudate, a plane of a “fin” and a plane of the surface where the fin is attached to the main tube body form an angle, in which typically the angle is an acute one (more typically an angle is substantially less than 60 degrees which may approximate that of a free end on the surface of a rolled cylinder formed from sheet); refer to angle “a” from 0200E in FIG. 2 whose measurement is about 30 degrees and where the two lines may be referred to as the planes forming the angle; again, refer to angle “b” from 0300C in FIG. 3 whose measurement is about 40 degrees and where the two lines may be referred to as the planes forming the angle. Typically a “fin” is present on the exterior (external) surface of the main body part of a finned tubular component (the fin may be referred to as exterior fin herein); in some embodiments, a “fin” is present on the interior (internal) surface of the main body part (the fin may be referred to as interior fin). Typically, an overall length of a fin is substantially equal to an overall length of the tube body part.

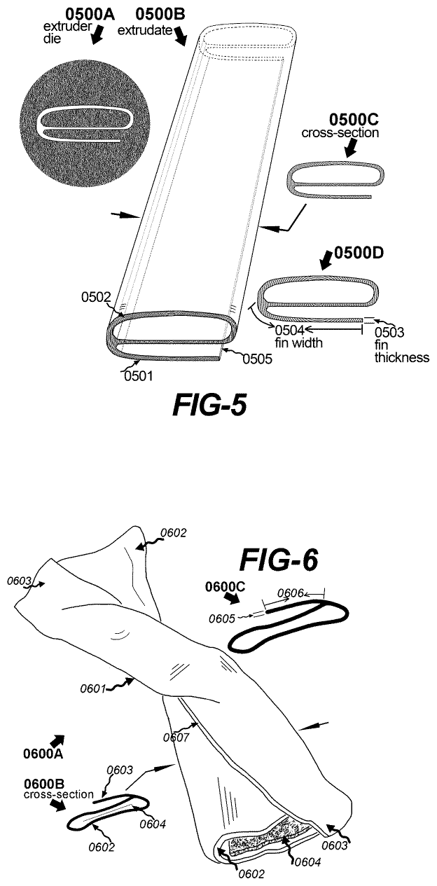

In some preferred embodiments, a “fin” inherently exists on an extruded tubular component/extrudate generated by an extruder, where the “fin” is dictated and inherently created by the extruder die design. The width of a fin is defined as a measurement that measures the distance along the material (in a direction substantially perpendicular to the longitudinal center line of the main tube body) from the surface of the main tube body (where the fin is attached to the tube body) to the far end (or extreme end, or furthest end or edge) of the fin (refer to the method of determining width in example fin width 0504 from FIGS. 5 and 0606 from FIG. 6; refer to edge 0505 and edge 0607 as furthest edge of the fin part 0501 and fin part 0603 respectively; also as shown in FIG. 4, edge 0438 refers to a far edge of fin part 0434 and edge 0439, far edge of fin edge 0436) of a finned tubular component. For the aforementioned exterior fin, in some preferred embodiments, the average thickness and the average width (the width measured in a way starting at the tube body surface till the far edge of the fin) are in a ratio less than 1:1 (more preferably a ratio less than 1:3), where the ratio ranges may provide visually “thin” property to the fin (for example, when a width is set at a fixed value, e.g. 8 mm, the less the ratio is, the thinner the fin looks). A “tubular object/component/extrudate with fin” may also be called “finned tubular object/component/extrudate” or “tube-shaped object/component/extrudate with fin” in the disclosure. When a rectangular sheet is rolled into a rolled cylindrical profile (along its width, for example) by rolling about one time along its width or by wrapping around itself multiple times, naturally there may be a free end (remaining end part) of the sheet extending (or protruding) from the rolled cylinder edge (or protruding from the main rolled cylinder body part in a circumferential direction). The fin (esp. on exterior surface of tube body part) on the tubular object/component as taught in the present disclosure may look like (or approximate) a free end part of a rolled rectangular sheet, in which the sheet is rolled into a hollow rolled cylinder with a free end (remaining end part) of the sheet extending (or sticking out, or protruding) from the rolled cylinder edge (or protruding from the main cylinder body part in a circumferential direction), thus making the “finned tubular object/component” much close to an illusion that the finned object/component is formed form a sheet material rather than a tube. In this fashion, the main tube body part of the “tubular object/component with fin” corresponds to the rolled cylinder main body formed by the sheet and the fin part corresponds to the free end (remaining end part) of the sheet extending (or protruding) from the rolled cylinder edge (or protruding from the main cylinder body part in a circumferential direction). As illustrated in FIG. 2, Finned Tubular Extrudate 0200A is formed of an extrudate formed by mono-extrusion process, where the fin part is annotated with the word of “fin” thereat and also indicated by numbering as 0201, a projecting thin piece sticking out from the main tube body of Finned Tubular Extrudate 0200A and extending along the length of the main body. Rolled Sheet Cylinder 0200C is initially in a flat rectangular sheet form and then rolled into a rolled cylindrical profile along its width by rolling about one time with a free end (remaining end part) of the sheet extending from the rolled cylinder edge (or protruding from the main rolled cylinder body part in a circumferential direction), where the free end (remaining end part) is labeled with the texts of “free end” over there and also indicated by numbering 0202. Comparing Finned Tubular Extrudate 0200A and Rolled Sheet Cylinder 0200C in the drawing, Finned Tubular Extrudate 0200A in appearance as a whole greatly resembles Rolled Sheet Cylinder 0200 in shape and structure and contributing to the presence of the fin part, the fin on the Finned Tubular Extrudate 0200A makes it much close to an illusion that Finned Tubular Extrudate 0200A is formed form a sheet material, where the Fin Part 0201 projecting thin piece sticking out from the Extrudate main body of Finned Tubular 0200A looks nearly identical in structure/configuration/shape to the Free End 0202 at an end of the sheet extending from the rolled cylinder edge (or protruding from the main cylinder body part in a circumferential direction). Cross-section 0200B and Cross-section 0200D refer to the cross-sectional views of Finned Tubular Extrudate 0200A and Rolled Sheet Cylinder 0200C respectively. Another benefit that a finned tubular component may provide may be that: it can generate comparatively greater width extrudate (this width is counted in a method that the finned tubular component is converted into a corresponding sheet by fully spreading into a sheet) when the corresponding sheet for comparison is extruded with a same diameter extruder die, which the capability is increased for a same extruder equipment. For example, the maximum extruder die diameter that a specific extruder equipment can take is 12 cm, which can produce at most 10 cm wide sheet extrudate. While applying the same extruder equipment to produce a finned tubular component, it may produce an extrudate with 35 cm width (the width is counted as the finned tubular component is converted into a corresponding sheet by fully spreading into a sheet). Yet another benefit that a finned tubular component may provide is that: a fin(s) appearing on the surface of main tube body can obtain a favorable surface texture thus providing favorable mechanical tooth cleaning effect. Typically, the average width of a “fin” on a finned tubular object (component) in the present disclosure is at least 2 mm. 2 mm width fin could be the least size that could provide the desired benefits of introduction of a “fin” to a tubular component described in the disclosure. Typically, the average thickness of a “fin” ranges from 0.2 mm to 10 mm (more typically 0.3 mm to 5 mm). Typically, the average wall thickness of the tube body part of a finned tubular component ranges from 0.2 mm to 20 mm (more typically 0.3 mm to 5 mm). Typically, the average thickness of a “fin” on a finned tubular object (component) in the present disclosure and the average thickness of the wall of the main body part of the finned tubular object (component) are in a ratio between 1:10 and 10:1 (more typically between 1:5 and 3:1), in which a fin with an average thickness out of the ratio could make it quite away from the imitation of a free end part to a rolled sheet cylinder object. More typically, an average thickness of the tube body part is equal to or greater than an average thickness of the fin. In some embodiments, the average thickness of a “fin” on a finned tubular object (component) in the present disclosure is either equal to, similar to, less than or no significantly larger than the average thickness of the wall of the main body part of the finned tubular object (component), in which it could serve an excellent imitation purpose of a free end part to a rolled sheet cylinder object formed of a common sheet material with an approximately homogeneous thickness through the material. Refer to 0500D from FIGS. 5 and 0600C from FIGS. 6, 0503 and 0605 refer to the “thickness” of the fins and 0504 and 0606, the “width” of the fins, which shows how the present disclosure defines “thickness” and “width” of the fins through the disclosure.

Refer to FIG. 4, the average thickness of fin 0408, fin 0410 and fin 0412-0425 respectively is equal to or similar to the average wall thickness of the corresponding main body part of the finned tubular components. The average thickness of fin 26-30 respectively is less than the average wall thickness of the corresponding main body part of the finned tubular components.

The total number of “fin(s)” present on the exterior surface of a finned tubular component/object/extrudate (or also be referred to as tubular object/component/extrudate with fin) is typically one. There is naturally only a single free end (remaining end part) of a sheet extending (or protruding) from the edge of a rolled cylinder (or protruding away from exterior surface of the main cylinder body part along the circumference in a circumferential direction) formed by rolling the sheet. As shown in FIG. 4, each of extrudates 0401C, 0402C, 0403C, 0406C, 0407C, 0451C, 0452C, 0401M, 0402M, 0403M, 0406M, 0407M, 0451M and 0452M to make a finned tubular object/component has a single “fin”, so does finned tubular extrudate 0200A from FIG. 2. But in some embodiments, the number of “fin(s)” could be larger than one, for example two or three as desired. As yet shown in FIG. 4, each of extrudates 0404C and 0404M has two “fins”, and 405C and 0405M, three “fins”. It is noted that the number of the exterior “fin(s)” on a “tubular object (component) with fin” article is preferred to be no greater than three since a tubular object/component with four or more fins on its exterior surface may in appearance be significantly away from the illusion purpose that the object/component were formed form a sheet material since there is naturally only a single free end (remaining end part) of the sheet extending (or protruding) from the rolled cylinder edge (or protruding away from exterior surface of the main cylinder body part in a circumferential direction). A tubular object/component with four or more fins on its exterior surface seems far away from a single free end (remaining end part) of the sheet sticking out from the rolled cylinder edge (or protruding from the main cylinder body part in a circumferential direction). As for the embodiments that the fin(s) present on the interior surface of a finned tubular component/object/extrudate, while the number of “fin(s)” may be typically one, the number of “fin(s)” may vary as desired.

The term of “collagen” in the present disclosure under a broader sense may refer to any form of collagen, in which the collagen may be present in the forms including but not limited to: a collagen molecule, a collagen chemical, a collagen compound, a collagen supplement (natural or synthetic), a compound consisting essentially of collagen molecule, a collagen composite consisting essentially of collagen molecule, collagen molecule/chemical/compound contained in a naturally-occurring material as a source of collagen, a collagen peptide (“collagen peptide” herein is derived from collagen through a process such as enzymatic hydrolysis process, which breaks down the large collagen molecules into smaller peptides and this enzymatic process results in collagen peptides with a low molecular weight, making them highly bioavailable and casily absorbed; “collagen peptide” may also be referred to as “hydrolyzed collagen” in some cases), a hydrolyzed collagen, extracted collagen molecule from animal natural parts and any combination thereof. Typically, the term “collagen” in the present disclosure refers to any one of: a collagen molecule, a collagen chemical, a collagen supplement (natural or synthetic), a collagen peptide, a hydrolyzed collagen and any combination thereof. Some “collagens” in the present disclosure may be prepared by hydrolysis or extraction from natural Animal Parts such as cartilage, skin, and tendon. Regarding collagen extraction, collagen can be basically obtained by chemical hydrolysis and enzymatic hydrolysis. In some embodiments, “collagen” particularly refers to corium (dermis) part of animal skin treated by enzymatic method. In some embodiments, “collagen” may refer to various collagen types and the term of “collagen” in the present disclosure may be of any types such as UC-II, type I, III, IV, V, X. Collagen type I has a rod-like structure made of three helically coiled chains. Fibrillar collagen such as the corium (or dermis) layer of animal skin (such as bovine skin, porcine skin, beef hide, porkhide) may be of type I collagen as the most abundant fibrillar collagen in most tissues is type I collagen. Fibrillar collagen is primarily present in fibril surfaces and connective tissues of the skin and bones. “Collagen” is a protein that is crucial for dog's overall well-being. It makes up a significant part of the skin, bones, tendons, and other connective tissues. Undenatured type II collagen (also known as UC-II collagen) for dogs, in particular, may play a vital role in joint health. Among the various types of “collagens” aforementioned, UC-II Collagen may play a critical role in dog's overall health, from boosting joint mobility to enhancing their skin and coat. UC-II collagen is a form of undenatured type II collagen that may be prepared by extraction from animal cartilage (e.g., chicken sternum cartilage). Unlike hydrolyzed collagen, UC-II collagen retains its original triple-helix structure. This unique structure plays a key role in its effectiveness for joint health. In some embodiments, the collagen constituent in a pet chew of the present disclosure is UC-II collagen.

As a contrast, “collagen” in a scientific definition in a narrower sense may refer to the fundamental elements of various connective tissues in animal bodies (such as skin, tendons, and ligaments), as one of the most abundant proteins in animal bodies produce, which may be made from three chains of amino acids arranged into a helix pattern that may be found in animal muscles, tendons, cartilage, skin and bones. Amino acid glycine may be present in most collagen chains, with proline and hydroxyproline also being common.

The term of “animal skin (esp. bovine skin, porcine skin)” may refer to a skin material composed of several layers, where the layers may include epidermis layer (epidermis may also be referred to as tough outer layer), dermis layer (dermis may also be referred to as corium). A hypodermis (flesh layer may be a part of the hypodermis) layer may also be mentioned, but in the industry, the hypodermis layer may not be considered a part of “animal skin”.

The term of “collagen-based” in the present disclosure may refer to a composition material containing any one of: at least 20% naturally-collagen-rich material by weight, at least 10% collagen (constituent, element, or ingredient) by weight and a combination thereof. Typically, the “collagen-based” composition contains at least 25% (more typically, at least 30%) naturally-collagen-rich material by weight or at least 10% collagen (constituent, element, or ingredient) by weight, where “at least 25% naturally-collagen-rich material” in the composition may be in accordance with the “dinners, entrees, platters, nuggets, recipe and formulas” rule under existing AAFCO labeling requirement. In some embodiments, all naturally-collagen-rich material ingredient(s) existing in the “collagen-based” composition added together account for the number one proportion ingredient(s) in the material by weight, which is larger than any other individual (or single) ingredient existing in the material (such as corn starch, isolated soybean protein, chicken, chicken liver, glycerin, sugar, sorbitol, and vegetables). In some embodiments of the present disclosure, the “collagen-based” composition contains at least 50% naturally-collagen-rich material by weight, in which naturally-collagen-rich material may serve as a majority ingredient by weight in the constitution of the composition. To form the finned tubular component (or the extruded sheet, or the extruded tubular component), in some preferred embodiments, the “collagen-based” composition contains no greater than 90% naturally-collagen-rich material (or no greater than 80% collagen constituent) by weight, which may well accommodate the extrusion process requirements for extruding the composition and may produce a durable extrudate in final end product. In some embodiments of the present disclosure, typically the “collagen-based” composition contains at least 25% (more typically at least 30%) collagen (constituent, element, or ingredient) by weight in final end product, where “at least 25% collagen (constituent, element or ingredient)” in the composition may meet the “dinners, entrees, platters, nuggets, recipe and formulas” rule under existing AAFCO labeling requirement. In some embodiments of the present disclosure, the “collagen-based” composition contains at least 50% collagen (constituent, element, or ingredient) by weight, in which collagen (constituent, element or ingredient) may serve as a majority constituent by weight in the constitution of the composition. In some embodiments of the present disclosure, to form the “collagen-based” composition, the naturally-collagen-rich material is any one of: corium (layer) part of animal skin (animal skin such as beef skin, pork skin, bovine skin, porcine skin), dermis (layer) part of animal skin (animal skin such as beef skin, pork skin, bovine skin, porcine skin), innermost layer of animal skin (animal skin such as beef skin, pork skin, bovine skin, porcine skin), inner layer of animal skin (animal skin such as beef skin, pork skin, bovine skin, porcine skin), cartilage, trachea, animal car, poultry foot, esophagus, animal pizzle, ligament, pericardium, animal tendon, eggshell membrane and any combination thereof. The phrase “-based” generally means: (in a composition material) containing something as an important feature (or important part) (e.g., lead-based paints, collagen-based composition). The term of “naturally-collagen-rich” (equal to “inherently-collagen-rich) material, mainly as a particular meat by-product, in the present disclosure generally refers to any one of: a naturally occurring animal material (or a natural Animal Part material, or a natural organ material) that inherently/naturally contains at least 50% collagen (where collagen constituent may exist as a majority constituent by weight in the material); an animal material that is derived from a naturally occurring animal material (or a natural Animal Parts material, or a natural organ material) that inherently/naturally contains at least 50% collagen without aid of added collagen (where collagen constituent may exist as a majority constituent by weight in the material); and any combination thereof. Some typical examples of these “naturally-collagen-rich” material includes: corium (layer) part of animal skin, dermis (layer) part of animal skin, innermost layer of animal skin, inner layer of animal skin, cartilage, trachea, animal car, poultry foot, esophagus, animal pizzle, ligament, pericardium, animal tendon, eggshell membrane, and any combination thereof. Corium (layer) or dermis (layer) part of animal skin (refer to dermis 1901 of a beef skin in FIG. 19 as an example), commonly obtained from bovine skin, porcine skin, ovine skin or caprine skin and especially obtained from bovine skin or porcine skin, may be a preferred embodiment of the “naturally-collagen-rich” material employed in the present disclosure as it usually contains at least 70% collagen (an example of corium layer of cattle skin sourced from a supplier contains about 89% collagen) and is of easy acquisition from the market. Preferably, the corium layer of animal skin does not undertake the process that rawhide regularly is prepared by as described in the definition paragraph of “rawhide” in the disclosure. Corium layer may be referred to as split (grain) layer as well. The particular layer of skin for rawhide manufacture such as the epidermis layer (refer to epidermis 1902 of a beef skin in FIG. 19 as an example) may be particularly avoided due to the reasons mentioned somewhere in the present disclosure. The layer of “junction of epidermis and corium” (refer to layer 1903 of a beef skin in FIG. 19) may also be used as a “naturally collagen-rich” material to make a pet chew in conjunction of corium layer as a part of the corium layer while sometimes the layer of “junction of epidermis and corium” could be an inferior material choice. In some embodiments, the “collagen-based” material may refer to an “animal skin corium layer-based” material formed from a composition including 25%-90% (or typically 50%-90%) corium layer of animal skin ingredient by weight in formula, in which animal skin corium layer ingredient preferably accounts for the number one proportion ingredient by weight, which is larger than any other individual (or single) ingredient existing in the material (e.g. corn starch, isolated soybean protein, glycerin, chicken liver, sugar, sorbitol). Examples of “naturally-collagen-rich” material may also include non-rawhide animal skins such as poultry skin, turkey skin, ostrich skin, fish skin (they are not available for leather manufacture industry) while sometimes they could be of an inferior choice. Collagen content data of some specific meat by-products may be referred to as follows (actual collagen content may vary from these according to actual tested samples): corium layer of skin-89%, tendon-85%, intestine-19%, lung-18%, stomach-13%, animal bone-24%, kidney-5.2% and liver-2%. As for “meat” (muscle), it may contain less than 10% collagen. Other meat by-product materials (meat as well) that inherently contain less than 50% collagen may not be included in the scope of the definition of “naturally-collagen-rich” material because: applying the material in the aim of increasing the collagen content in a pet chew may ask for comparatively much more proportion of this material in the chew extrudate and the large proportion may not comply with other materials to produce an extrudate or not be adapted to the following extrusion process or even ruin the following extrusion process to produce a chewing-durable component to make an end product of a chew. (Notes: According to AAFCO, the “25%” or “dinner” rule applies to many canned and dry products. If the named ingredients comprise at least 25% of the product (not counting the water for processing), but less than 95%, the name must include a qualifying descriptive term, such as “Dinner” as in “Beef Dinner for Dogs”). Typically, a collagen-based composition material in the present disclosure has a chemical (e.g., humectant chemical such as glycerin, sorbitol) in the formula. In some embodiments, a collagen-based composition material in the present disclosure may have 2%-35% humectant (more typically 10%-25% humectants; humectants such as glycerin, sorbitol) ingredients as a kind of chemical in addition to naturally-collagen-rich material (or collagen constituent) ingredient.

A “cartilage-based” material may refer to a material including at least 25% cartilage constituent (or element, or ingredient) by weight in the composition.

“Gelatin” is made by heating or treating collagen and forms a gel when cooled. Gelatin may be formed by the partial hydrolysis of collagen, where hydrolysis breaks down the secondary and higher bonding interactions between the crosslinked polypeptide chains, resulting in the loss of the collagen's fibrous structure and the production of gelatin. As a contrast, “collagen peptide” herein is derived from collagen through a process such as enzymatic hydrolysis process, which breaks down the large collagen molecules into smaller peptides and this enzymatic process results in collagen peptides with a low molecular weight, making them highly bioavailable and easily absorbed. “Collagen peptide” may also be referred to as “hydrolyzed collagen” in some cases. “Collagen peptides” are soluble in water including cold and hot water, but “gelatin” is only soluble in hot water and will gel when cooled. If the intended health goal of feeding is to up dog's amino acids to help boost its natural collagen production, then in most cases, highly digestible collagen peptide in a chew recipe will be most beneficial. Both collagen and gelatin are proteins that contain amino acids. Collagen peptide or hydrolyzed collagen has been broken down into even smaller pieces than gelatin, making this type of collagen more bioavailable. In this bioavailability perspective, collagen peptides are a better option than gelatin as used in a chew recipe.

“Glucosamine” in the present disclosure may refer to a Glucosamine chemical, or a Glucosamine molecule, or a Glucosamine compound, or a Glucosamine supplement, or a compound containing Glucosamine, or a Glucosamine constituent. “Chondroitin” in the present disclosure may refer to a Chondroitin chemical, or a Chondroitin molecule, or a Chondroitin compound, or a Chondroitin supplement, or a compound containing Chondroitin, or a Chondroitin constituent. Glucosamine/Chondroitin may be introduced to the pet chews of the present disclosure by means as follows: directly applying a synthetic Glucosamine/Chondroitin supplement substance or Glucosamine/Chondroitin supplement substance obtained by extraction and/or chemical process (examples include glucosamine sulfate, glucosamine hydrochloride (HCL), N-acetyl-glucosamine or MSM glucosamine, glucosamine chondroitin, glucosamine chondroitin sulfate, glucosamine chondroitin MSM, chondroitin sulfate, chondroitin sulfate sodium, and chondroitin hydrochloride) into the formula as an ingredient.

In some embodiments of the present disclosure, it is to provide a pet chew including an ingredient selected from the group consisting of: a naturally glucosamine-rich material, a naturally chondroitin-rich material, a synthetic glucosamine, a synthetic chondroitin, a glucosamine supplement material, a chondroitin supplement material, a glucosamine compound, a chondroitin compound, a glucosamine sulfate, a chondroitin sulfate, a glucosamine hydrochloride, a chondroitin hydrochloride and any combination thereof, in the chew, providing joint health benefits to dogs. In at least one embodiment of these, it is to provide a pet chew including an ingredient selected from the group consisting of (by weight): at least 3% trachea material, at least 3% esophagus material, at least 3% cartilage material, at least 3% naturally cartilage-rich material, at least 3% naturally glucosamine-rich material, at least 3% naturally chondroitin-rich material, at least 0.2% synthetic glucosamine, at least 0.1% synthetic chondroitin, at least 0.2% glucosamine supplement material, at least 0.1% chondroitin supplement material, at least 0.2% glucosamine compound, at least 0.1% chondroitin compound, at least 0.2% glucosamine sulfate, at least 0.1% chondroitin sulfate, at least 0.2% glucosamine hydrochloride, at least 0.1% chondroitin hydrochloride and any combination thereof, in the chew.

The term “composition” or “composite” in the present disclosure generally may refer to a product of mixing or combining two or more ingredients or elements (or constituents, or materials), esp. a mixture of the ingredients (elements or materials). But it should be noted that, somewhere in the present disclosure, the term of “composition” may also refer to the ingredients (parts) of which something is composed or made of; constitution. For example, a tubular component of a pet chew is made of a meat-based “composition” material, where the formula of the meat-based composition material includes the ingredients of chicken breast and corn starch and chicken liver (three distinct ingredients herein), in which the ingredients may be ground, blended and mixed together before formed into an end product. Again, for example, a collagen-based extruded sheet component is made of a collagen-based “composition” material, where the formula of the collagen-based composition material includes the ingredients of potato starch, ground chicken cartilage and glycerin (three distinct ingredients herein). The “composition” material (or composition material) may be formed by any workable or desired recipe, examples of which may be a collagen-based material, plant-based material, or a corium of beef skin-based material. Usually, a “composition” material is an artificial material rather than a naturally occurring material (e.g., a corium layer of beef skin employed as a single ingredient material is a naturally occurring material). Examples of the aforementioned naturally occurring materials may include a corium layer of porcine skin, chicken cartilage, turkey tendon and beef trachea obtained from slaughtered from animals and employed as a single ingredient material. Edible pet chews may be divided into two categories, the Natural Chews (such as the chews derived from a certain Natural (Body) Part (organ) of a slaughtered animal) and the Composite Chews (chews made of composite materials or artificial composite materials). “Natural Chews” generally are made of naturally occurring materials such as beef trachea, beef rawhide sheet, chicken breast, beef hooves, beef bones, antler, etc. “Natural part (organ)” generally refers to a part (an organ) of a slaughtered animal such as beef rawhide, beef bones, chicken leg, pizzle, beef tendon, chicken breast, trachea, esophagus, chicken liver, etc., which could be rendered by a simply drying process before being served to a dog. On the other hand, if a natural part (for example, beef tendon) is pre-treated by a grounding process, where its natural inherent form is thus altered, mixed with other materials such as potato starch and sorbitol to make a composite, shaped by a mold to take a stick shape and then finally harden and dried to a stick-shaped chew, it thus makes a Composite Chew.

The term “longitudinal” or “longitudinally” generally in the present disclosure generally means “running/extending from one end of an object to the other rather than across it from side to side; in a direction or position along the length of something”. For examples, when a fin extends longitudinally on the surface of a finned tube component, it runs in a direction from one opening of the tube to the other. In contrast, “latitudinal” or “latitudinally” in the present disclosure generally means “in a direction widthwise, or horizontally, or substantially perpendicular to the centerline (longest axis) of an object”. For example, when something extends “latitudinally” on/in the surface of a tubular object, it runs/extends along a circumference of the tubular object in a direction substantially perpendicular to the centerline (longest axis) of the tubular object.

It should be noted the term of “rawhide sheet” or “rawhide” in the chew industry as a most popular material to form dog chews, generally refers to a layer of skin/hide obtained from slaughter of animals (especially the animals such as bovine, porcine, cattle, cow, water buffalo and pig), which is made of a by-product of the leather industry. The “rawhide” may not be exposed to tanning process or may be partially tanned and generally fur, meat and fat is removed. It may also be called traditional rawhide. As a typical process to prepare the rawhide, split the layer of skin to a number of more layers according to pre-determined thickness, soak the split layers in lime solution and clean (and bleach) the skins in rolling drums, have it sterilized with hydrogen peroxide, and dry the skin layers to a moisture content less than 30% or so. In the whole process, a range of chemicals, such as lime solution, NaOH, NH₄Cl, are deployed. The term of “rawhide-free animal skin” or “animal skin free of rawhide” in the present disclosure refers to the animal skin layer materials that are free of aforementioned rawhide and/or the aforementioned manufacturing process and does not fall into the definition of aforementioned rawhide. “Corium (dermis) layer of animal skin” or “innermost layer of animal skin” as employed in the present disclosure is an embodiment of the “rawhide-free animal skin”. Compared to rawhide material that is largely used in chew recipe for decades, since “corium (dermis) layer of animal skin” collagen material is made from much more natural sources, they are considered to be much less involved in adding chemicals in the process of hide manufacture or even free of the chemical additives (such as NH₄CL, H₂O₂ and NaOH) commonly found in rawhide material production. What's more, rawhide may not be easily digestible and end up causing unnecessary digestive discomfort. The corium (dermis) layer of animal skin typically is made from natural sources of collagen, such as beef skin. Unlike rawhide, corium (dermis) layer of animal skin undergoes minimal processing, making them a more natural option. Since corium (dermis) layer of animal skin is made from natural sources, they are free of the chemical additives commonly found in rawhide manufacture. This makes it a more natural treat option.

In a narrow sense, the term of “sheet” generally refers to a thin flat material (after its being spread, unfolded, unrolled or flatted out in certain cases), which is thin in comparison to its length and breadth, typically in a square or rectangular shape, of which both opposite sides (the top side and the bottom side) are substantially smooth and of which the thickness typically is substantially homogeneous throughout the material (a common sheet in narrow sense has a homogeneous thickness, however, a sheet in narrow sense may alternatively have different thickness in different part of it). While referring a material as being “thin”, it means that the distance between the two opposite sides (the top side and the bottom side) of the material in comparison to its length and breadth is small. Typically, the average thickness of a “sheet” ranges from 0.2 mm to 20 mm (more typically 0.3 mm to 5 mm). Alternatively, the “sheet” in narrow sense may be in any desired shapes or forms other than the aforementioned rectangular shape. Alternatively, the “sheet” in narrow sense may initially be in a flat form with a cross-section shape of a flat line and finally be shaped (for example by curving, bending, folding, rolling, knotting or wrapping) to a final form with a cross-section shape of a curve (similar to the curves as presented by cross-section shapes of extrudate 0800E-0800J in FIG. 8), or to a final form of Bi Fold (sheet with a single fold, both of almost equal size), Tri Fold (sheet with 2 folds, with 3 sections flaps folding inward) or Z Fold (sheet is folded into Thirds, with 2 folds and with 3 sections of equal or different size; flaps fold back and forth to make a Z). Alternatively, the “sheet” in narrow sense may initially be in a curved form with a cross-section shape of a curve, or initially be in a form of Bi Fold (sheet with a single fold, both of almost equal size), Tri Fold (sheet with 2 folds, with 3 sections flaps folding inward) or Z Fold (sheet is folded into Thirds, with 2 folds and with 3 sections of equal or different size; flaps fold back and forth to make a Z), where the initial forms are produced by extrusion process through extruder dies with a pre-designed extruder die orifice shape and configuration (refer to the cross-section shapes of extrudate 0800E-0800J as illustrated in FIG. 8), which could also obtain a flat “sheet” if the initial forms being spread or unfolded by some means. It should be noted that, the “sheet” from traditional rawhide sheet and the sheet shape of beef skin or pork skin widely employed to make a chew fall into the aforementioned narrow sense of “sheet”. Thus, an artificial composition material formed into the form of aforementioned “sheet” in narrow sense is considered a good imitation of the natural shape of traditional rawhide sheet (e.g., the beef rawhide and pork rawhide) as a popular chew material. In a broad sense, the term of “sheet” refers to a thin material, which is thin in comparison to its length and breadth, typically in a square or rectangular shape, the sides of which may be smooth or textured, or ribbed (for example, a side of a sheet has a longitudinal ridge or rib on surface; refer to the sheet extrudates as illustrated in 0800C and 0800D in FIG. 8; 0800D has two longitudinal ridges and would get a kind of ribbed sheet if more similar ridges being applied); a sheet under the broad sense may alternatively have an edible coating layer or basting layer on a side of the sheet and since the coating layer or basting layer is subject to be inseparable by hand or is not subject to peel off from the sheet, coating layer or basting layer is generally considered a part of the sheet itself and coated sheet as a whole still well falls into the definition of “sheet” in broad sense. The term “sheet” in the present disclosure in majority circumstances may refer to the aforementioned narrow sense while it may follow the aforementioned broad sense in others. For example, the “sheet(s)” generated by extruder die designs of 0800A, 0800B, 0800E, 0800F, 0800G, 0800H, 0800I and 0800J as illustrated in FIG. 8 may refer to a sheet in the narrow sense), whereas the “sheet(s)” of 0800C and 0800D may refer to a sheet in the broad sense instead.

The term “tube” (or “tubular”, or “pipe”, or tube-formed) in the present disclosure generally refers to a long hollow object that may be round or not, whose cross-section shape may be various as desired. A typical cross-section of the tube/pipe is in a round (circular) outline (profile) shape, an O-shape, or in a closed-circle outline (profile) shape, or in a closed-curve outline (profile) shape. The outline (profile) shape of the tube's/pipe's cross-section may be in other various shapes, such as an oval shape, a rounded-triangular shape, a rounded-rectangular shape, a polygonal shape, a shape resembling Arabic numerals “8” (twin-tube form), a shape of three-circle (a triple-tube form shape), a shape of water-drop icon, and irregular shapes. A tube has an opening at each end. Typically, the average wall thickness of it ranges from 0.2 mm to 20 mm (more typically 0.3 mm to 5 mm). Typically, the average wall thickness of a tube to the average diameter of the whole tube is in a proportion no greater than 1:3, which could make its hollow core form fairly distinguishable in appearance (a hollow core plays an important role in the definition of a tube). In some embodiments of the present disclosure, the exterior surface of the tube has a fin part running along the length of the tube, forming a finned tubular component. The outline (profile) shape of the finned tube cross-section may be in a shape resembling Arabic “9” or a shape of comma of punctuation mark. A tube/pipe without fin part may be referred to as “traditional/common/ordinary/normal tube/pipe” or “traditional/common/ordinary/normal tubular component” in the disclosure. A “tube” may alternatively have an edible coating layer or basting layer on a surface of the tube and since the coating layer or basting layer is subject to be inseparable by hand or is not subject to peel off from the tube, coating layer or basting layer is generally considered an inseparable part of the tube itself and coated tube as a whole still well falls into the aforementioned definition of “tube”, where the material(s) forming the coating or basting layer is considered a part of the ingredient(s) forming the “tube”. The quality of “durable” in the present disclosure generally refers to a feature of a chew or a chew component material that is in a certain durability, and/or rigidity/hardness, and/or elasticity, and/or toughness/flexibility, which can endure a dog's (fairly) long time chewing after its being served to a dog and before it is swallowed. The elements of “finned tubular component”, “extruded traditional tubular component” or “extruded sheet” described in the present disclosure may be a “durable” one. The hardness of them may typically range from Shore D 15 to 65. “Tensile strength” may be used as another particular specification to describe “durable” quality of a material. The typical tensile strength of the elements of “finned tubular component”, “extruded traditional tubular component” or “extruded sheet” may be at least 0.5 mPa, more typically 0.5 mPa to 5 mPa.

In order to achieve a “durable” tubular chew component, the chew component may be formulated intentionally and carefully. According to the inventor's tests, “collagen constituent” or “naturally-collagen-rich” material in a collagen-based composition material can facilitate the durability achievement. In an embodiment of the present disclosure, it is to provide an edible pet chew including a finned tubular component or an extruded traditional tube component (or an extruded sheet component) made of a collagen-based composition material, where the component in composition has a collagen material and/or naturally-collagen rich material.

To determine the proportion of “collagen (constituent)” or “naturally-collagen-rich material” in a collagen-based material, tests are conducted by the inventor. Refer to “Table I” below titled “Tabel 1: Durability tests for chew composition with various collagen constituents”. In the tests, a group of composition materials in a formula with a range of “collagen constituent” proportions are involved, ranging from 5% to 32% (No. 2-18 compositions). Among them, the No. 1 composition does not have any collagen constituent, utilized as a starting point of “chew durability”, i.e., 8.1 minutes chewing time durability as indicated therein, thus providing “chew durability” comparisons to other compositions with various collagen constituents. The No. 2-18 compositions following it contain gradually increasing proportions of collagen ranging from 5%-32%. And the collagen constituent from the various compositions of No. 2-18 compositions can be substantially equally obtained by converting them to “corium layer of beef skin” compositions respectively as listed in the column of “Proportion of “corium layer of beef skin” (ground form) in formula” as indicated in Table 1. Taking No. 14 composition as an instance, it contains 25% collagen in the composition, when “corium layer of beef skin” (corium layer of beef skin as a naturally-collagen-rich material having approximately 83% collagen constituent) is employed to provide collagen to a similar composition constitution, the composition having 30% “corium layer of beef skin” will get about 25% collagen which is substantially equal to No. 14 composition.

TABLE 1

| | | Proportion | | |
|---|---|---|---|---|
| | | of Collagen | | |
| | Proportion | constituent | | |
| | of “corium | (in the | | |
| | layer of | composite | | |
| | beef skin” | of the chews | | Chew |
| | (ground | composed of | | Durability* |
| Numbering of | form) in | an extruded | | (unit: |
| compositions | formula | tube) | Ingredient List | minutes) |
| 1 | | 0% | 0% collagen, 60% plant, 25% | 8.1 |
| | | | chicken breast, 15% chemicals | |
| | | | (glycerin, sorbitol) | |
| 2 | | 5% | 5% collagen, 60% plant, 20% | 7.8 |
| | | | chicken breast, 15% chemicals | |
| | | | (glycerin, sorbitol) | |
| 3 | | 7% | 7% collagen, 60% plant, 18% | 8.2 |
| | | | chicken breast, 15% chemicals | |
| | | | (glycerin, sorbitol) | |
| 4 | | 8% | 8% collagen, 60% plant, 17% | 8.7 |
| | | | chicken breast, 15% chemicals | |
| | | | (glycerin, sorbitol) | |
| 5 | | 9% | 9% collagen, 60% plant, 16% | 8.5 |
| | | | chicken breast, 15% chemicals | |
| | | | (glycerin, sorbitol) | |
| 6 | | 10% | 10% collagen, 60% plant, 15% | 10.8 |
| | | | chicken breast, 15% chemicals | |
| | | | (glycerin, sorbitol) | |
| 7 | | 11% | 11% collagen, 60% plant, 14% | 10.7 |
| | | | chicken breast, 15% chemicals | |
| | | | (glycerin, sorbitol) | |
| 8 | | 13% | 13% collagen, 60% plant, 12% | 11 |
| | | | chicken breast, 15% chemicals | |
| | | | (glycerin, sorbitol) | |
| 9 | | 14% | 14% collagen, 60% plant, 11% | 12.6 |
| | | | chicken breast, 15% chemicals | |
| | | | (glycerin, sorbitol) | |
| 10 | 20% | 15% | 15% collagen, 60% plant, 10% | 12.5 |
| | | | chicken breast, 15% chemicals | |
| | | | (glycerin, sorbitol) | |
| 11 | | 16% | 16% collagen, 60% plant, 9% | 12.5 |
| | | | chicken breast, 15% chemicals | |
| | | | (glycerin, sorbitol) | |
| 12 | | 22% | 22% collagen, 60% plant, 3% | 13.3 |
| | | | chicken breast, 15% chemicals | |
| | | | (glycerin, sorbitol) | |
| 13 | | 24% | 24% collagen, 60% plant, 1% | 13.8 |
| | | | chicken breast, 15% chemicals | |
| | | | (glycerin, sorbitol) | |
| 14 | 30% | 25% | 25% collagen, 60% plant, 0% | 16.5 |
| | | | chicken breast, 15% chemicals | |
| | | | (glycerin, sorbitol) | |
| 15 | | 27% | 27% collagen, 58.4% plant, 0% | 15.3 |
| | | | chicken breast, 14.6% | |
| | | | chemicals (glycerin, sorbitol) | |
| 16 | | 28% | 28% collagen, 57.6% plant, 0% | 17.1 |
| | | | chicken breast, 14.4% | |
| | | | chemicals (glycerin, sorbitol) | |
| 17 | | 30% | 30% collagen, 56% plant, 0% | 25.3 |
| | | | chicken breast, 14% chemicals | |
| | | | (glycerin, sorbitol) | |
| 18 | | 32% | 32% collagen, 54.4% plant, 0% | 24.9 |
| | | | chicken breast, 12.6% | |
| | | | chemicals (glycerin, sorbitol) | |

Remarks:
“Tabel 1: Durability tests for chew composition with various collagen constituents”
Specification of tested bones: size-4.5″, weight-55 g
Testing dog: French bulldog, weight 24 lbs, aged 4
*Minutes counted from the first bite until its being completely swallowed

According to the tests from Table 1 above, when the collagen (constituent) proportion increases to 10% (No. 6 composition), an over ⅓ longer “durability” than No. 1 composition is observed. When the collagen proportion increases to 15% (No. 10 composition), an over ½ “durability” than No. 1 composition is observed. When the collagen proportion increases to 25% (No. 14 composition), a double “durability” chewing time of No. 1 composition is observed. When the collagen proportion increases to 30% (No. 17 composition), a triple “durability” chewing time of No. 1 composition is observed. Based on the tests, the collagen-based composition of the present disclosure is supposed to have over 10% collagen constituent in formula. And typically, the collagen-based composition has over 25% (more typically over 30%) collagen constituent. And in the scenarios that a naturally-collagen-rich material (having over 50% collagen constituent), the collagen-based composition of the present disclosure is supposed to have over 20% naturally-collagen-rich materials in formula. And more typically, the collagen-based composition has over 30% naturally-collagen-rich materials in formula.

The term “starch” in the present disclosure generally refers to a carbohydrate food substance obtained from a plant. Some examples include starches derived from potato, sweet potato, mung bean, wheat, corn, tapioca, rice, pea, and mixtures thereof. The starch can be used in its native form, but it may also be physically or chemically modified before being applied. Of course, it is also possible to use combinations of native starch and modified starch, or combinations of different modified starches.

It should be noted that the term “plant” in the present disclosure generally refers to an edible part of a plant or an edible material derived from a plant, where the plant material includes, but not limited to: a plant material (such as potato, sweet potato, mung bean, wheat, corn, tapioca, rice, pea, soybean, peanut, almond, mushroom, legumes, beans, grains, chia seed, algae, seaweed, spirulina, cereals and mixtures thereof), a material of edible part of a plant, a plant derived material, a plant protein, a plant starch, a plant fiber, a vegetable material, a vegetable derived material, a vegetable protein, a vegetable starch and mixtures thereof.

The term “plant-based” refers to a composite (or composition) material including substantially at least 50% plant ingredient(s) by weight in the formula. Usually, all plant ingredients (such as plant starch, plant protein, and plant fibers) existing in the “plant-based” composite/composition added together account for the number one proportion ingredient(s) in the material by weight, which is larger than any other individual (or single) non-plant ingredient existing in the material, such as glycerin, chicken, chicken liver, sugar, and sorbitol. Non-plant ingredient(s) existing in the material may be any one of: meat (meat by-product) ingredient, rawhide-free animal skin ingredient, animal skin corium layer ingredient, naturally collagen-rich materials, chemicals and a combination thereof. Preferably, a plant-based material of the present disclosure is free of rawhide ingredients. Alternatively, a plant-based composition material in the present disclosure may have 2%-35% humectant (more typically 10%-25% humectants; humectants such as glycerin, sorbitol) ingredients as a kind of chemical in addition to plant ingredient.

“Animal ingredient” refers to the materials obtained from a slaughtered animal (such as vertebrate animal, livestock animal, bovine, porcine, ovine, caprine, poultry and fish), including meat, meat by-product (including animal skin) or a combination thereof, other than feather, horn, hair, teeth, hooves. The term of “meat” generally refers to the clean flesh derived from slaughtered animals (including but not limited to mammals, livestock, bovine, porcine, cattle, pig, poultry, chicken, duck, turkey and fish) and is limited to that part of the striate muscle which is skeletal or that part which is found in the tongue, in the diaphragm, in the heart or in the esophagus; with or without the accompanying and overlying fat, sinew, nerve and blood vessels which normally accompany the flesh. In other words, “meat” may refer to primarily the muscle tissue of an animal. Exemplary materials include poultry flesh, bovine flesh, ovine flesh, caprine flesh, turkey flesh, chicken flesh, beef, pork, and fish flesh. The term of “meat by-product(s)” in the present disclosure generally refers to (preferably non-rendered) clean parts, other than meat, derived from slaughtered animals (such as mammals, fish, and poultry), which includes, but is not limited to skin, cartilage, trachea, animal car, poultry foot, esophagus, animal pizzle, ligament, pericardium, tendon, lungs, spleen, kidneys, brain, livers, blood, bone, partially defatted low-temperature fatty tissue, stomachs and intestines free of their contents and a combination thereof. “Meat by-product” may also be a material selected from the group consisting of: corium (dermis) layer of skin, eggshell membrane, milk, milk powder, milk-derived material, cheese, cheese-derived material, whey, whey protein powder, whey-derived material, egg, and egg-derived material. Some other exemplary materials are chicken liver, bovine tendon, bovine lungs, porcine fat, beef bone powder and pig stomach. The term of “meat-based” in the present disclosure may refer to a composition material having 30%-99% (typically 30%-60%) meat (or meat by-product, or a combination of meat and meat by-product) ingredient by weight on an as formulated basis or on an as fed basis and 20%-50% plant ingredient by weight on an as formulated basis or on an as fed basis. Alternatively, a meat-based (or a meat by-product-based) composition material in the present disclosure may have 2%-35% humectant (more typically 10%-25% humectants; humectants such as glycerin, sorbitol) ingredients as a kind of chemical in addition to meat (or meat by-product) ingredient.

“Attractant” material (it may also be referred to as flavor material) in the present disclosure may refer to a material having a flavor that is applied to entice pets/dogs to chew on and cat. Examples of the attractant are chicken liver, hydrolyzed animal protein, hydrolyzed chicken liver, poultry digest, chicken digest, artificial beef flavor, artificial pork flavor, meat ingredient, meat by-product ingredient, and brewer yeast.

It should be noted that the term “assemble” means to fit together all separate parts/members/components of a pet chew product. For example, several separate components of a pet chew are manipulated (such as knotting, wrapping, stuffing, rolling, folding, braiding, and twisting) by hand or by machine to have the components together form a pet chew product in a predetermined relationship.

In one aspect of the present disclosure, an edible pet chew is provided including an extruded tubular (or tube-shaped) component (or also be referred to as a finned tubular component, finned tube component) having a (main) tube body part and a “fin” part on a surface of the body part, formed form a finned tubular extrudate. Typically, the tubular form/structure of the extruded finned tubular component is not natural and is produced or created artificially by machine or equipment. Preferably, the finned tubular component as a chew component is a durable finned tubular component that can endure dog's chewing for quite a long time.

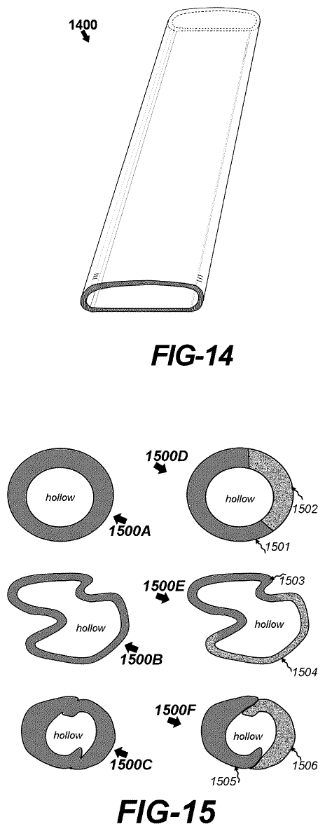

On the market, a kind of popular rawhide sheet chews has been thriving for over decades and contributing to the great manipulability of the sheet element of the rawhide materials in manufacture, these sheets can be easily manipulated in a method such as being folded, being wrapped, rolled, braided, knotted and shaped by hand, and thus these sheet materials can be shaped/manipulated/formed into various end product structures/configurations such as knotted bone, rolled cylindrical shape, twisted sticks, braided shapes, etc. Also, on the market, a lot of pet chews made of an artificial extruded sheet (the sheet in a recipe of composition material, particularly a plant-based composition material) free of rawhide can be found. As the sheet element of these extruded sheet chews has a shape/configuration/structure/property nearly identical to the rawhide sheet material of a rawhide chew, these extruded sheet pet chews can nearly be formed, shaped, or manipulated into every forms/configurations/structures that a common rawhide sheet chew can be done into. Thus, to some extent, these extruded sheet pet chews can well substitute the traditional rawhide chews in some cases, being broadly welcome by dog owners and their dogs as a new generation “rawhide alternative” chews. The applicant points out that, a regular standard, normal, common or ordinary “extruded tube” (the object as illustrated in FIG. 14 is an example of a standard “extruded tube”) that can be found on the market could be considered a rolled rectangular sheet that is rolled along the width of the sheet or by curling up the short sides of the sheet with two edges at the length of the sheet merged, joined or combined together (although the merge of the edges does not actually happen in real practices and either the merge would not be supported by existing manufacture technology. Note: the merge is merely based on an imagination and is not practical). It should be noted that, in the chew industry, extruded sheet chew and extruded (ordinary) tube chew stay distinct from each other and run distinctly, and there is no cross. To some extent, common extruded tube is not identical to extruded sheet, but for a certain number of pet chews on the market formed of extruded sheet with particular final product configuration/structure/shape, common extruded tubes may well substitute extruded sheet to form the same chews so that at first sight, it is not easy to identify the difference in appearance between the original extruded sheet chews and their substitutes. But, through careful observations, the inventor identified some problems with these common extruded tubes that, in the aspect of substitution to artificial extruded sheet material, due to the inherent material differences between extruded sheet and extruded tube in structure/configuration/form, for a majority of pet chews formed of extruded sheet, the substitution either cannot be well fulfilled by these common extruded tube materials or does not result in a satisfying substitution (for example, chews made of extruded tube are not able to easily wrap a piece of chicken jerky externally in a way of making the chicken jerky on the chews visible to dogs as the chews made of extruded sheet do; chews made of extruded sheet in FIG. 12 may be able to facilitate the understanding how a piece of chicken jerky is wrapped in a rolled sheet externally visible on the chew). However, the inventor points out that, the finned tubular component, as a solution, is invented in the present disclosure to solve the kind of problems. The finned tubular component not only provides an improved substitute to extruded sheet, but also it may bring more unexpected advantages such as saving labors for wrapping or rolling procedure in manufacturing in comparison to extruded sheet. The naturally closed curve or closed circle structure of the tube body part of the finned tubular component is able to maintain its inherent closed area during manipulating step and following step(s) so that (internal) wrapping relationship (if applicable) is prone to stay as desired avoiding an unwanted loose or open wrapping as rolled sheet could incur and things infilled (if applicable) inside tube body part are prone to be wrapped tight. What is more, a pet chew having a finned tubular component formed by co-extrusion so as to include a fin part in a different appearance from the main tube part that may provide an illusion that a strip of edible material (i.e., the fin part) additionally is wrapped in the pet chew. For examples, the finned tubular component is formed by co-extrusion having a first food material to form the main tube body part and a second food material to form the fin part, in which the body part and the fin part are formulated differently in color and flavor, and the fin part in a different color would create an illusion that a new edible material separate from the tube body part is wrapped in the chew though the fin and the tube body part are actually integrally formed.

### Process

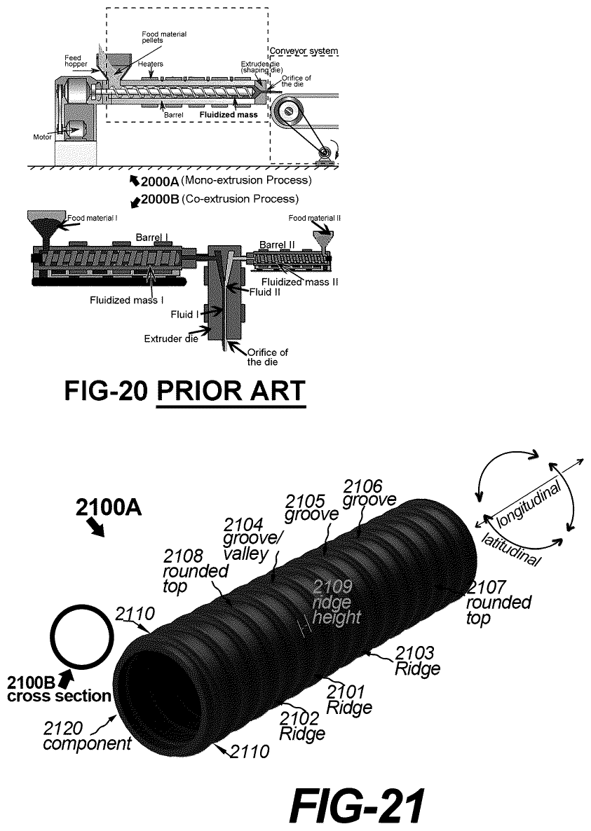

Typically, the aforementioned finned tubular component/extrudate is formed by a mono-extrusion or a co-extrusion process creating the (main) tube body part and the fin part together simultaneously. As shown in FIG. 20, process 2000A is an example of a common mono-extrusion and process 2000B, a common co-extrusion. In the process of mono-extrusion as shown in process 2000A, food material is prepared by mixing various ingredients (e.g., beef skin corium layer, corn starch, chicken breast, glycerin, sorbitol, potassium sorbate) together and grounding to a ground form and then the food material is fed into feed hopper and comes to the barrel. The screw conveyer inside the barrel carries the food material (in pellets, granular form, or powdered form) forward by the action of the screw and squeezes it, and, with heat from the heaters and the friction of viscous flow, changes it to a fluidized mass (molten stream). As it does this, it develops pressure on the food material, which is highest right before the fluidized mass enters the die. The pressure on the fluidized mass forces it through an adapter and into the extruder die (shaping die) and it leaves the extruder at the orifice of the die, which dictates the shape of the final extrudate. In the process of co-extrusion as shown in process 2000B, two separate food materials are involved, food material I and II, formulated differently, similarly or identically. Separate extruders are required for each distinct material in the coextrusion, in which the left is a first extruder and the right, the second one, sharing a single extruder die. The coextrusion process involves the simultaneous flow of separate food materials with different characteristics within the same equipment to produce a multi-layer extrudate. In each extruder, the pressure on the fluidized material I or II forces it into the same extruder die where the fluidized mass I and II are combined and merged together, and after they leave the extruder die at the orifice of the die, it dictates the shape of a final multi-layer extrudate. After the extrusion process, long and consistent extrudate may be divided to smaller pieces with desired length (As an optional step herein according to pre-determined end product, the divided small piece of extrudate may be assembled with an additional edible component such as a slice of chicken jerky) and then put into oven for drying process, where the drying process dehydrates it to a desired moisture content (e.g. 12%) and hardens it to a final end product status.

In the scenario that the finned tubular component/extrudate is formed by co-extrusion technology, in an exemplary co-extrusion process, taking the extrudate 0401C design from FIG. 4 as an instance in conjunction with the example of co-extrusion process as shown in FIG. 20, a first material (food material I) to produce the (main) tube body part and a second material (food material II) to produce the fin part are heated in the barrels respectively by heaters into fluidized mass I and II and finally shaped by the same extruder die and exit through the orifice of the extruder die creating a multi-layered extrudate 0401C, of which the two materials can be formulated differently, similarly or identically. As shown in FIG. 4, extrudates 0401C, 0402C, 0403C, 0404C, 0405C, 0406C, 0407C, 0451C and 0452C are examples of finned tubular components formed by co-extrusion process. The multi-layered extrudate 0401C has a fin 0408 and a main body part 0409. As aforementioned, co-extrusion generally refers to a simultaneous extrusion of two or more materials through the same die, creating a multi-layered or multi-part extrudate. The technique allows to combine the desirable properties of multiple materials (the aforementioned first material and the second) into a single structure with enhanced performance characteristics. In the scenario that the finned tubular component is formed by mono-extrusion technology, as shown in FIG. 4, extrudates 0401M, 0402M, 0403M, 0404M, 0405M, 0406M, 0407M, 0451M and 0452M are examples of finned tubular components formed by mono-extrusion process. Mono-extrusion (or mono-layer-extrusion) generally refers to an outmoded process of forming the profile from a single material into a desired shape and size.

Thanks to the inherent material property, after a “finned tubular component” extrudate leaves extruder and cools, it has a certain elasticity. The elasticity allows the extrudate to lose its original shape or form to some extent after its being manipulated by machine or hand (e.g., manipulation by rolling, twisting, braiding, stuffing, knotting, folding, wrapping, etc.) in the following shaping step during manufacture. For example, in FIG. 6, the extrudate to form the bow tie chew 0600A is initially a finned tubular component with a round tube main body; in following shaping step, the extrudate is twisted by hand to a final bow tie shape; after the shaping step, the main tube body loses its original round shape. It is foreseen that, even a more serious deformation that may happen to a finned tubular component extrudate in end product in present disclosure than 0600A still makes it fall into the definition that the end product of the pet chew is formed of a finned tubular component. This deformation rule applies to the extrudates from aspect of “extruded sheet” and aspect of “extruded ordinary tubular component” of the present disclosure as well as described in other paragraphs.

As shown in FIG. 5, a pet chew in shape of hollow cylinder as an embodiment in the aforementioned aspect of the present disclosure is formed from extrudate 0500B composed of a fin part 0501 and a tube body part 0502, which is generated by extruding a food material with a mono-extrusion extruder through extruder die 0500A. Cross-section 0500C shows a cross-section view of the extrudate. Extrudate 0500B may be heat treated to take a dehydrating process and hardened to a final end product.

In some embodiments of aforementioned aspect of the present disclosure, it is to provide an edible pet chew including a finned tubular component formed from an extrudate, where the component is further manipulated, formed or shaped (such as knotting, wrapping, rolling, folding, braiding and twisting), optionally in conjunction with introduction of an additional edible component assembled with the extrudate component, into the shape/structure/configuration of a final end product, where the additional edible component herein is referred to as a second component and the finned tubular component does as a first component.

As shown in FIG. 3, pet chew 0300A in shape of twisted stick as an embodiment in the aforementioned aspect of the present disclosure formed of a finned tubular component is presented. The finned tubular component is formed form a mono-extrusion extrudate 0300B having a main tube body 0302 and fin 0301. With the inherent material property, after extrudate 0300B leaves extruder and cools, it has a certain elasticity. The elasticity allows extrudate 0300B to lose its original shape to some extent after its being twisted by machine or hand in the twisting shaping step during manufacture. For example, the area 0303 of main tube body 0302 bends inward greatly, where the main tube body loses its original circular shape. Even a more serious deformation happening to a finned tubular component extrudate in end product in present disclosure than 0300B still makes it fall into the definition that the end product of the pet chew is formed of a finned tubular component.

Refer to FIG. 4, chart 0400A and chart 0400B display a group of exemplary finned tubular extrudates produced by different extruder die designs to make pet chews of some embodiments the present disclosure. Extrudates 0401M, 0402M, 0403M, 0404M, 0405M, 0406M, 0407M, 0451M and 0452M are examples of finned tubular components formed by mono-extrusion process, and extrudates 0401C, 0402C, 0403C, 0404C, 0405C, 0406C, 0407C, 0451C and 0452C, co-extrusion.

0408, 0410, 0412-0428, 0430, 0432, 0434, 0436 and 0437 refer to fin parts of the several finned tubular extrudates and 0409, 0411, 0432, 0429, 0431, 0433 and 0435, main tube body parts, of which each of fins 0408, 0412, 0414, 0417, 0422, 0426, 0428, 0432 and 0436 is formed from a second food material distinct from those for making the corresponding main tube body parts. Taking finned tubular extrudate 0405C as an instance, it is produced by co-extrusion employing a first food material to form main tube body part 0432 and fin 0420/0421 and a second food material to form fin 0422. Fin 0422 may be formulated differently from fin 0420/0421 as desired to present different property such as palatability, attraction and visuality. 32 34 36 37

In yet some embodiments of the present disclosure, a pet chew further includes an additional edible material as a second component assembled with the first component, the aforementioned extruded finned tubular component. In an embodiment, the additional edible material component is wrapped in the extruded finned tubular component, where at least a portion of former may be covered by the latter without exposure. In an embodiment, the additional edible material component is a porous material (typically formed from a plant-based material or a collagen-based material) wrapped in the extruded finned tubular component. In an embodiment, the additional edible material component wraps the extruded finned tubular component, where at least a portion of latter may be covered by the former without exposure. In an embodiment, the additional edible material component and the extruded finned tubular component are assembled in a relationship that the first and second component form alternating layers in that assembly. In some embodiments, the additional edible material is a naturally-collagen-rich material, a naturally-Glucosamine/Chondroitin-rich material, or a naturally-cartilage-rich material, such as corium layer of animal skin, porcine tendon, turkey cartilage, beef trachea and beef lung. In an embodiment, the additional edible material is an animal cartilage material such as beef cartilage, chicken cartilage and porcine cartilage. In an embodiment, the additional edible material is a trachea (or an esophagus) material.

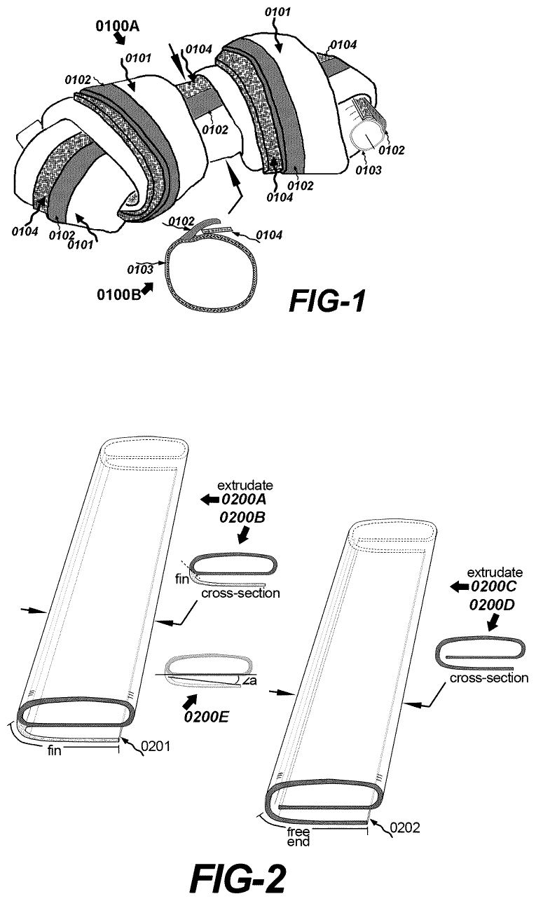

Refer to FIG. 1, pet chew 0100A in a shape of knotted bone as an embodiment of the present disclosure formed form finned tubular component 0101 and edible material 0104 is presented. The finned tubular component is formed form a co-extrusion extrudate having a main body part 0103 and fin part 0102. Cross-section 0100B shows a view of the cross-section at the middle of the knotted bone. Alternatively, edible material 0104 may be a thin piece of chicken jerky. Fin part 0102 and main body part 0103 may be formed separately of two composition materials formulated as required or as desired.

Refer to FIG. 6, pet chew 0600A in shape of bow tie as an embodiment of the present disclosure formed form a finned tubular component 0601 and edible material 0604 is presented. Finned tubular component 0601 is formed form a co-extrusion extrudate having a main body part 0602 and fin part 0603. Cross-section 0600B shows a view of the cross-section at a position of the bow tie chew. Alternatively, edible material 0604 may refer to an extruded sheet made of cheese-based composition.

In some embodiments of the present disclosure, an edible pet chew is provided including a finned tubular component (extruded tubular component with fin), in which the finned tubular component has an edible coating layer or basting layer on a surface of it as an inseparable portion of it.

In some embodiments of the present disclosure, an edible pet chew is provided including a finned tubular component (extruded tubular component with fin), in which the finned tubular component is manipulated (such as twisting, knotting, curving or shaping by hand or machine) into a final product shape as desired such as a shape of twisted tube, knotted bone, tube ring, braids (braiding with at least two separate similar finned tubular components together), pretzel, dumbbell (including two edible doughs strung on the finned tubular component), kabob (including three edible doughs strung on the finned tubular component), spiral, etc. It is foreseen that the aforementioned finned tubular component that is initially in an approximately-straight tube form may be deformed and shaped by any pre-determined method into any other final product shapes as desired. Note: the embodiments related to the methods to form various final product forms described in this paragraph for finned tubular component can be replicated to form the final product forms for the following aspect of “extruded ordinary tubular component” and aspect of “extruded sheet component”.

In an aspect of the present disclosure, a method of preparing an edible pet chew is provided. The steps of the method include: A), preparing an extruder and an extruder die with a Die Orifice design in a pre-determined shape or structure that may generate finned tubular extrudate as desired; B), preparing materials (such as ground beef skin corium, tapioca starch, ground chicken cartilage, humectants and other chemicals), having them mixed (blended) so as to get a composition material in accordance with any one of the formulas provided by the present disclosure, and feeding it into the extruder; C), a long continuous finned tubular extrudate is thus produced; D), cutting the long extrudate material into numerous pieces in a pre-determined length; E (an optional step), having it manipulated into a final product shape, optionally in conjunction with another new edible material; F), dehydrating or drying by heating treatment. This method may also be applied to similarly prepare pet chews disclosed in the aspect of “extruded ordinary tubular component” and aspect of “extruded sheet component”

### Formula

It is foreseen that, the finned tubular component in the present disclosure may be formed from any composition materials formulated as required or as desired.

In some embodiments of the present disclosure, it is to provide an edible pet chew including an extruded plant-based tubular (or tube-shaped) component (or also be referred to as a finned tubular component) having a (main) tube body part and a fin part on the surface, in which the plant-based finned tubular component is made of a plant-based (artificial) composite/composition having at least 50% plant ingredient. In at least one embodiment of these aforementioned, the edible pet chew includes at least 3% UC-II collagen in the formula.

In an embodiment, a composition (formula) of the plant-based composition is provided including (by weight): 50%-90% plant material, 2%-40% humectants (more typically 10%-30% humectants; humectants such as glycerin, sorbitol). It may be free of rawhide. The composition may further include additives such as an attractant (e.g., dried brewer, dried chicken breast powder, chicken digest, hydrolyzed chicken liver and artificial beef flavor), a colorant (such as calcium carbonate) and a preservative (such as potassium sorbate). The formula is a plant-based material one. In an exemplary particular formula embodiment, the composition (formula) is: Potato Starch (67.5%), Chicken breast (8%), Water (12%), Glycerin (11%) and beef liver (1.5%). In this formula, plant ingredients totally occupy 67.5% of the formula, meat by-product ingredient 1.5%, and meat 8%. Glycerin may serve as an additive or a chemical. In yet another exemplary particular formula embodiment, the formula of the composition is: Rice flour (67.2%, classified as plant ingredient), vegetable glycerin (8%), gelatin (7%), fresh chicken breast (5%, classified as meat ingredient), ground bovine tendon (3%, classified as meat by-products ingredient), cellulose powder (2%, classified as plant ingredient), calcium carbonate (2%), sweet potato (2%, classified as plant ingredient), lecithin (1%), carrageenan gum (1%), hydrolyzed pizzle (0.5% classified as meat by-product ingredient), brewer's yeast (0.5%), titanium dioxide (0.4%), FD&C yellow 6 (0.2%), FD&C red 40 (0.1%), FD&C blue 1 (0.1%). In this formula, plant ingredient(s) totally occupy 71.2% (67.2%+2%+2%) of the formula, meat by-products ingredient 3.5%, and meat ingredient 5%. Vegetable glycerin may serve as a humectant chemical. Gelatin, calcium carbonate, carrageenan gum, titanium dioxide, FD&C yellow 6, FD&C red 40 and FD&C blue 1 may serve as some chemicals. Ground bovine tendon is applied as a meat by-product ingredient as well as a naturally-glucosamine/chondroitin-rich material.

In an embodiment of the present disclosure, a composition (formula) of the plant-based material is provided including (by weight): 50%-80% plant material, 2%-40% humectants (more typically 10%-30% humectants; humectants such as glycerin, sorbitol), 0.1%-20% meat or meat by-product ingredient (such as poultry digest, chicken liver, chicken meal, chicken breast powder, fish, bone powder). The composition may be free of rawhide. The composition may further include additives such as an attractant (e.g., dried brewer, dried chicken breast powder, chicken digest, hydrolyzed chicken liver and artificial beef flavor), a colorant (such as calcium carbonate) and a preservative (such as potassium sorbate). The composition may further include a material serving as a natural source of collagen such as trachea, chicken cartilage. In an embodiment, the composition (formula) is: Tapioca (50%), Wheat starch (14%), Water (13%), Soybean protein (8%), Pork (5%), Ground Shark Cartilage (3%), Ground crab shell (2%), Sorbitol (3%) and Xanthan gum (2%). In this formula, plant ingredients totally occupy 72% (50%+14%+8%) of the formula, and meat (meat by-product) 10% (5%+3%+2%). Sorbitol may serve as a humectant, and Xanthan gum, a chemical or additive.

In an embodiment of the present disclosure, a composition (formula) of the plant-based material is provided including (by weight): 45%-70% plant starch material, 5%-20% plant protein material, 2%-40% humectants (more typically 10%-30% humectants; humectants such as glycerin, sorbitol), 0.1%-30% meat or meat by-product (such as poultry digest, chicken liver, chicken meal, chicken breast powder, fish), 0.1%-8% attractant or flavor material (such as dried brewer yeast, hydrolyzed animal protein, chicken liver and hydrolyzed plant protein). The composition may be free of rawhide. The composition may further include additives such as an attractant (such as dried brewer, hydrolyzed chicken liver), a colorant (such as titanium dioxide) and a preservative (such as potassium sorbate). In an embodiment, the composition (formula) is: Sweet potato (52.7%), Potato starch (10%), Isolated pea protein (10%), Chicken breast powder (5%), Cattle liver powder (1%), Fructose (3%), Gelatin (2%), Bone powder (3%), Water (12%), Hydrolyzed chicken liver (1%), Sodium pyrophosphate (0.3%). In this formula, plant ingredients totally occupy 72.7% (52.7%+10%+10%) of the formula, and meat (meat by-product) 9% (5%+1%+3%). Isolated pea protein may also work as a humectant as well as plant ingredient. Fructose and gelatin may serve as chemicals or additives. Hydrolyzed chicken liver may serve as an attractant.

In some embodiments of the present disclosure, it is to provide an edible pet chew including an extruded tubular (or tube-shaped) component (or also be referred to as a finned tubular component) having a (main) tube body part and a fin part on the surface, in which the finned tubular component is made of a (artificial) composition having 10%-30% meat ingredient and 20%-50% plant ingredient, and optionally 2%-35% humectants (more typically 10%-25% humectants; humectants such as glycerin, sorbitol). In an exemplary particular formula embodiment, the composition (formula) is: Frozen chicken breast (26%), Potato (25%), Wheat starch (13%), Water (13%), Soybean protein (8%), Sorbitol (13%) and Xanthan gum (2%). In this formula, meat (meat by-product) totally occupies 26% of the formula, and plant ingredients 46% (25%+13%+8%). Soybean protein may also work as a humectant as well as plant ingredient. Sorbitol works as a humectant. Xanthan gum may serve as a chemical or additive. In at least one embodiment of these aforementioned, the edible pet chew includes at least 3% UC-II collagen in the formula. In an exemplary particular formula embodiment, the formula of the composition is: Cheese (20%), Whey protein powder (6%), Potato starch (22%), Pea starch (20%), Glycerin (15%), Sorbitol (7%), Gelatin (5%), Guar Gum (2%), Salt (1%), Xanthan Gum (1%), Citric acid (0.5%), Sodium citrate (0.3%), Potassium sorbate (0.1%), FD&C Yellow 6 (0.1%). In this formula, meat (meat by-product) totally occupies 26% of the formula (cheese 20%+whey protein powder 6%), and plant ingredient(s) 42% (22%+20%). Meat (meat by-product) (26%) is larger than any other individual (or single) non-animal ingredient existing in the composition, such as potato starch or pea starch. Glycerin and sorbitol may serve as humectant chemicals. Gelatin, guar gum, salt, xanthan gum, citric acid, sodium citrate, potassium sorbate and FD&C yellow 6 may serve as some chemicals.

In some embodiments of the present disclosure, it is to provide an edible pet chew including an extruded meat-based tubular (or tube-shaped) component (or also be referred to as a finned tubular component) having a (main) tube body part and a fin part on the surface, in which the meat-based finned tubular component is made of a meat-based (artificial) composite/composition having 30%-99% meat (or meat by-product, or a combination of meat and meat by-product) ingredient and 20%-50% plant ingredient, and optionally 2%-35% humectants (more typically 10%-25% humectants; humectants such as glycerin, sorbitol). In at least one embodiment of these aforementioned, the edible pet chew includes at least 3% UC-II collagen in the formula. In an exemplary particular formula embodiment, the formula of the composition is: Frozen Chicken Breast (24%), Corn Starch (47.5%), Cattle bone powder (5%), Beef liver (3%) and Glycerin (19%), Glucosamine Sulfate (1%) and Chondroitin Sulfate (0.5%). In this formula, meat (meat by-product) totally occupies 32% (24%+5%+3%) of the formula, and plant ingredients 47.5%. Glycerin may serve as a humectant chemical. Glucosamine sulfate and Chondroitin may serve as chemicals or supplements. In another exemplary particular formula embodiment, the formula of the composition is: Rice flour (43.6%, classified as plant ingredient), fresh chicken breast (30%, classified as meat ingredient), vegetable glycerin (8%), gelatin (7%), chicken cartilage (2%, classified as meat by-products ingredient), cellulose powder (2%, classified as plant ingredient), calcium carbonate (2%), sweet potato (2%, classified as plant ingredient), lecithin (1%), carrageenan gum (1%), brewer's yeast (1%), FD&C colorings (0.4%). In this formula, meat (meat by-product) totally occupies 32% of the formula (30%+2%), and plant ingredient(s) 47.6% (less than 50%). Vegetable glycerin may serve as a humectant chemical. Gelatin, calcium carbonate, carrageenan gum and titanium dioxide may serve as some chemicals. Chicken cartilage is applied as a meat by-product ingredient as well as a naturally-glucosamine/chondroitin-rich ingredient.

In another exemplary particular formula embodiment, the meat (meat by-product) based formula of the composition is: Fresh chicken breast (28%, classified as meat ingredient), tapioca starch (20%, classified as plant ingredient), ground shrimp shell (6%, classified as meat by-product ingredient), ground bovine lung (4%, classified as meat by-products ingredient), mussel meat (2%, classified as meat ingredient), gelatin (12%), vegetable glycerin (8%), beef car (5%, classified as meat by-product), sorbitol (3.6%), cellulose powder (3%, classified as plant ingredient), calcium carbonate (3%), sweet potato (2%, classified as plant ingredient), lecithin (1%), carrageenan gum (0.7%), brewer's yeast (1%), FD&C colorings (0.4%), Glucosamine Sulfate (0.2%) and Chondroitin Sulfate (0.1%). In this formula, meat (meat by-product) totally occupies 45% of the formula, and plant ingredient(s) 25%. Vegetable glycerin and sorbitol may serve as humectant chemicals. Gelatin, calcium carbonate, lecithin, carrageenan gum and titanium dioxide may serve as some chemicals.

In some embodiments of the present disclosure, it is to provide an edible pet chew including an extruded tubular (or tube-shaped) component (or also be referred to as a finned tubular component) having a (main) tube body part and a fin part on the surface, in which the pet chew as a collagen-based chew as a whole contains at least 25% collagen constituent (or element, or ingredient) in final end product counting in the collagen present in every component(s). “At least 25% collagen” in the chew may have it in accordance with the “dinners, entrees, platters, nuggets, recipe and formulas” rule under existing AAFCO labeling requirement. In some embodiments of the present disclosure, the pet chew as a collagen-based chew as a whole contains collagen constituent (or element, or ingredient) accounting for the number one constituent (or element, or ingredient) in final end product counting in the collagen present in every component(s). In some embodiments of the present disclosure, the pet chew as a collagen-based chew as a whole contains at least 50% collagen constituent (or element, or ingredient) by weight in final end product counting in the collagen present in every component(s), where collagen constituent may occupy the majority proportion in the chew. In at least one embodiment of the aforementioned embodiments, the finned tubular component is formed of a collagen-based composition material.

As an exemplary pet chew embodiment of aforementioned embodiments, a “collagen dinner” chew (total weight 20 g) is composed of a plant-based finned tubular component (16 g) and a piece of turkey tendon component (4 g), of which the finned tubular component has 10% collagen constituent (1.6 g) and turkey tendon as a naturally-collagen-rich material has 92% collagen constituent (3.68 g) in the material. Thus, totally 5.28 g (1.6 g+3.68 g) collagen exists in the chew as a whole, accounting for 26.4% of the weight of the chew.

In some embodiments of the present disclosure, it is to provide an edible pet chew including an extruded tubular (or tube-shaped) component (or also be referred to as a finned tubular component) having a (main) tube body part and a fin part on the surface, in which the extruded finned tubular component is formed of a (artificial) collagen-based composite/composition material having at least 20% (or 20%-90%) collagen-rich (naturally-collagen-rich) material by weight and/or at least 10% (or 10%-80%) collagen (constituent, element or ingredient) by weight. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal car, poultry foot, esophagus, animal pizzle, ligament, pericardium, animal tendon, eggshell membrane, and any combination thereof. In an exemplary composition (formula) embodiment of the aforementioned embodiments, the composition (formula) of the collagen-based composition is: Enzymatic hydrolysis processed corium layer of beef skin (55%, classified as naturally-collagen-rich material containing 89% collagen), Corn starch (10%), Pork (3%), Water (11%), Glycerin (15%), Sorbitol (5%) and hydrolyzed chicken liver (1%). As a method for composition interpretation, in this formula, naturally-collagen-rich material (i.e., skin corium layer) occupies 55% of the composition, plant ingredients 10%, meat by-product ingredient 1%, meat 3%. Glycerin and sorbitol may serve as humectants. As yet another method for composition interpretation for the same formula, collagen constituent totally occupies over 49% of the formula (55%*89%+ the collagen constituent from pork). Note: the embodiments related to formulas described in this paragraph for finned tubular component can be replicated to form the collagen-based compositions for the following aspect of “extruded ordinary tubular component” instead.

In some embodiments of the present disclosure, it is to provide an edible pet chew including an extruded tubular (or tube-shaped) component (or also be referred to as a finned tubular component) having a (main) tube body part and a fin part on the surface, in which the extruded finned tubular component is formed of a collagen-based composition material having 25%-80% (more typically 30%-80%) collagen (constituent, element or ingredient) by weight in final product.

In some embodiments of the present disclosure, it is to provide an edible pet chew including an extruded tubular (or tube-shaped) component (or also be referred to as a finned tubular component) having a (main) tube body part and a fin part on the surface, in which the extruded finned tubular component is formed of a collagen-based composition material having at least 10% meat ingredient by weight and any one of: at least 20% naturally-collagen-rich material by weight, at least 10% collagen (constituent, element or ingredient) by weight and a combination thereof. Alternatively, the composition may further have 2%-35% humectant (more typically 10%-25% humectants; humectants such as glycerin, sorbitol) ingredients.

In some embodiments of the present disclosure, it is to provide an edible pet chew including an extruded tubular (or tube-shaped) component (or also be referred to as a finned tubular component) having a (main) tube body part and a fin part on the surface, in which the extruded finned tubular component is formed of a collagen-based composition material having at least 10% meat ingredient by weight and any one of: at least 30% naturally-collagen-rich material by weight, at least 10% collagen (constituent, element or ingredient) by weight and a combination thereof. In some embodiments of the present disclosure, it is to provide an edible pet chew including an extruded tubular component formed of a collagen-based composition material having at least 30% meat ingredient by weight and any one of: at least 30% naturally-collagen-rich material by weight, at least 10% collagen (constituent, element, or ingredient) by weight and a combination thereof.

In some embodiments of the present disclosure, it is to provide an edible pet chew including an extruded tubular (or tube-shaped) component (or also be referred to as a finned tubular component) having a (main) tube body part and a fin part on the surface, in which the extruded finned tubular component is formed of a collagen-based composition material having at least 10% meat ingredient by weight, at least 20% plant ingredient by weight and any one of: at least 20% naturally-collagen-rich material by weight, at least 10% collagen (constituent, element or ingredient) by weight and a combination thereof. Alternatively, the composition may further have 2%-35% humectant (more typically 10%-25% humectants; humectants such as glycerin, sorbitol) ingredients. In an exemplary particular formula embodiment, the formula of the composition material is: Ground corium layer of beef skin (20%), Ground corium layer of porcine skin (10%), Wheat flour (25%), Rice (10%), Chicken breast (15%), Glycerin (9%), Sorbitol (2%), Peanut butter (2%, plant ingredient), Fructose (1%), Barley malt syrup (1%), Pork gelatin (2%), Salt (1%), Sodium Tripolyphosphate (0.5%), Potassium sorbate (preservative) (0.2%), Sodium pyrophosphate (0.2%), Xanthan gum (0.5%), Sodium propionate (preservative) (0.2%), Artificial flavoring (0.2%), FD&C Red 40 (0.1%), FD&C Blue 1 (0.05%), FD&C Yellow 6 (0.03%), FD&C yellow 5 (0.02%). In this formula, naturally-collagen-rich ingredient totally occupies 30% (20%+10%) of the formula, plant ingredients 37% (25%+10%+2%) and meat ingredient (15%). Glycerin, sorbitol, sodium tripolyphosphate and sodium pyrophosphate may serve as humectants or chemicals. Fructose, barley malt syrup, pork gelatin, salt, potassium sorbate, xanthan gum, sodium propionate, the flavoring and the colorants may serve as chemicals or additives. Also in this formula, naturally-collagen-rich ingredient totally accounts for at least 25% of the constitution of the finned tubular component composition (i.e. 30%), and all naturally-collagen-rich material ingredient(s) existing in the “collagen-based” composition added together account for the number one proportion ingredient (i.e. 30%) in the composition by weight, which is larger than any other individual (or single) ingredient (e.g. wheat flour as an individual ingredient) existing in the composition.

In some embodiments of the present disclosure, it is to provide an edible pet chew including an extruded tubular (or tube-shaped) component (or also be referred to as a finned tubular component) having a (main) tube body part and a fin part on the surface, in which the extruded finned tubular component is formed of a collagen-based composition material having at least 20% plant ingredient by weight and any one of: at least 20% naturally-collagen-rich material by weight, at least 10% collagen (constituent, element or ingredient) by weight and a combination thereof. Alternatively, the composition may further have 2%-35% humectant (more typically 10%-25% humectants; humectants such as glycerin, sorbitol) ingredients. In at least one embodiment of the aforementioned ones, the finned tubular component is formed of a collagen-based composition material having 20%-50% plant ingredient by weight and any one of: at least 50% naturally-collagen-rich material by weight, at least 25% collagen (constituent, element, or ingredient) by weight and a combination thereof.

In an exemplary composition (formula) embodiment of the aforementioned embodiments, the formula of the collagen-based composition is: Tapioca starch (30%), Collagen (25%, extracted collagen from swine bone, classified as collagen constituent), Pig ligament (3%, classified as a source of collagen, containing 80% collagen), Beef trachea (3%, classified as a source of collagen, containing 85% collagen), wheat flour (12%), Beef (3%), Water (12%), Glycerin (11%) and beef liver (1%). In this formula, collagen constituent totally occupies over 29.95% of the formula (25%+3%*80%+3%*85%+ the collagen constituent from beef and beef liver), plant ingredients 42%, meat by-product ingredient 1%, meat 3%. Glycerin may serve as an additive or a chemical. In yet another exemplary composition (formula) embodiment of the aforementioned embodiments, the composition (formula) of the collagen-based composition is: Tapioca starch (30%), Ground dermis layer of porcine skin (25%, classified as naturally-collagen-rich material), Pig tendon (3%, classified as naturally-collagen-rich material), Chicken cartilage (3%, classified as naturally-collagen-rich material), wheat flour (12%), Chicken (3%), Water (12%), Glycerin (11%) and beef liver (1%). In this formula, naturally-collagen-rich material totally occupies 31% of the formula (25%+3%+3%), plant ingredients 42%. Note: the embodiment related to formulas described in this paragraph for finned tubular component can be replicated to form the collagen-based composition for the following aspect of “extruded ordinary tubular component” instead.

In some embodiments of the present disclosure, it is to provide an edible pet chew including an extruded tubular (or tube-shaped) component (or also be referred to as a finned tubular component) having a (main) tube body part and a fin part on the surface, in which the edible pet chew has at least 3% UC-II collagen in the formula.

In some embodiments of the present disclosure, it is to provide a pet chew including a finned tubular component formed of a (artificial) composition material, in which the composition includes Glucosamine constituent (or element, or ingredient) and/or Chondroitin constituent (or element, or ingredient) or a naturally-Glucosamine/Chondroitin-rich material in it.

It is foreseen that rawhide (such as beef rawhide, pork rawhide, esp. in ground form) may be used as an ingredient to form the finned tubular component while it is involved in health concerns from consumers.

In another aspect of the present disclosure, an edible pet chew is provided including an extruded sheet component (formed from a sheet extrudate) formed of a collagen-based (artificial) composite/composition material having any one of: at least 50% (or 50%-90%) collagen-rich (naturally-collagen-rich) material by weight, at least 30% (or 30%-80%) collagen (constituent, element or ingredient) by weight and a combination thereof. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal car, poultry foot, esophagus, animal pizzle, ligament, pericardium, animal tendon, eggshell membrane, and any combination thereof. Typically, the extruded sheet component is formed by a mono-extrusion, or a co-extrusion process. Preferably, the extruded sheet component is a durable extruded sheet component. Typically, the sheet form of the extruded sheet component is not natural and is produced or created artificially by machine or equipment. In some embodiments of the present disclosure, the pet chew as a collagen-based chew as a whole contains collagen constituent (or element, or ingredient) accounting for the number one constituent (or element, or ingredient) in final end product counting in the collagen present in every component(s). In some embodiments of the present disclosure, the pet chew as a collagen-based chew as a whole contains at least 50% collagen constituent (or element, or ingredient) by weight in final end product counting in the collagen present in every component(s), where collagen constituent may occupy the majority proportion in the chew.

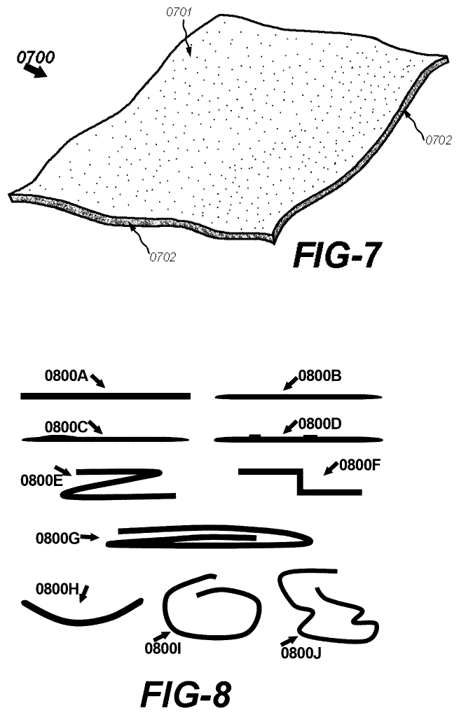

Refer to FIG. 7. Sheet 0700 is an embodiment of a part of extruded sheet in the aforementioned aspect of the present disclosure, which may work as a basic element to be further manipulated (such as by knotting, twisting, rolling, etc.) to a chew product, optionally in conjunction with another edible material component. It should be recognized that the length, width, and thickness (thickness 0702) of the sheet 0700 may vary as predetermined to make a pet chew with different sizes, shapes, and configurations. The size or area of the Sheet 0700 of FIG. 7 may vary according to predetermined request. The Sheet 0700 is divided or cut into small pieces in shape of rectangle or other specific shapes for further manipulating to a pet chew product. Sheet 0700 may be formed from a composition material formulated as required or as desired.

Refer to FIG. 8, cross-section views of a group of exemplary “extruded sheet component” extrudates according to some embodiments in the aforementioned aspect of the present disclosure are displayed therein, produced by various extruder die designs. Extrudates 0800A and 0800B may refer to some common shapes of extruded sheets. Both extrudate 0800E and extrudate 0800G are in a folded shape. Extrudate 0800H is in a curved shape, extrudate 0800I, a rolled shape and extrudate 0800J, an irregular shape.

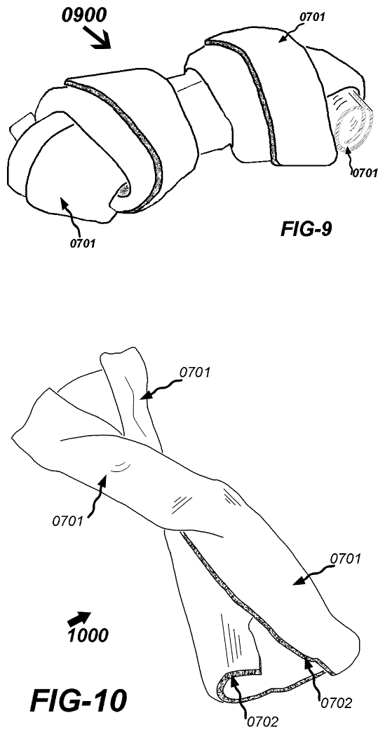

Refer to FIG. 9, a pet chew 0900 in shape of knotted bone as an embodiment of the present disclosure is formed from a collagen-based extruded sheet extrudate, which is generated by extruding a food material with a mono-extrusion extruder through extruder die with a die design shape similar to 0800B or 0800I.

Refer to FIG. 10, a pet chew 1000 in shape of bow tie as an embodiment of the present disclosure is formed from a collagen-based extruded sheet extrudate, which may be generated by extruding a food material with a mono-extrusion extruder through extruder die with a die design shape similar to 0800A or 0800G.

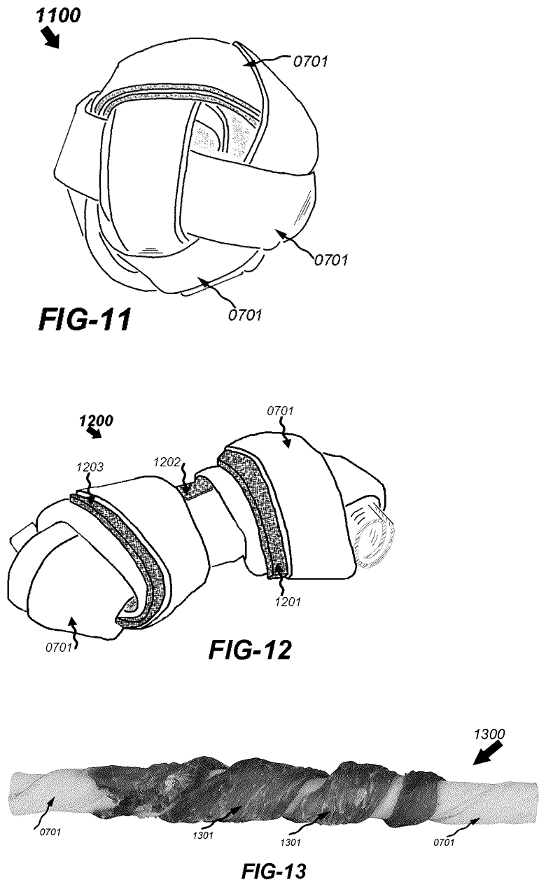

Refer to FIG. 11, a pet chew 1100 in shape of a ball as an embodiment of the present disclosure is formed from several pieces of collagen-based extruded sheets, which are manipulated by hand to a final ball shape.

In some embodiments of the present disclosure, an edible pet chew is provided including a collagen-based extruded sheet component, in which the component has an edible coating layer or basting layer on a surface of the it as an inseparable portion of it.

In some embodiments of the aforementioned aspect of the present disclosure, it is to provide an edible pet chew including an extruded sheet component formed from an extrudate, where the component is further manipulated, formed or shaped (such as knotting, wrapping, rolling, folding, braiding and twisting), optionally in conjunction with introduction of an additional edible component assembled with the extrudate component, into the shape/structure/configuration of the final end product, where the additional edible component is referred to as a second component and the extruded sheet component does as a first one.

Refer to FIG. 12, a pet chew 1200 in shape of knotted bone as an embodiment of the present disclosure is provided. A piece of collagen-based extruded sheet 0701 in conjunction with three pieces of meat-based strips 1201-1203 is shaped by knotting to a final end product shape with the three strips wrapped inside.

Refer to FIG. 13, a pet chew 1300 in shape of twisted stick as an embodiment of the present disclosure is provided. A piece of collagen-based extruded sheet 0701 is shaped by twisting into a final end product shape with a pieces of chicken strip 1301 wrapped on the surface.

### Formula

In some embodiments of the present disclosure, it is to provide an edible pet chew including an extruded sheet component formed of a collagen-based (artificial) composition material having at least 10% meat ingredient by weight and any one of: at least 50% naturally-collagen-rich material by weight, at least 30% collagen (constituent, element, or ingredient) by weight and a combination thereof. In some embodiments of the present disclosure, it is to provide an edible pet chew including an extruded sheet component made of a collagen-based composition material having at least 30% meat ingredient by weight and any one of: at least 50% naturally-collagen-rich material by weight, at least 30% collagen (constituent, element, or ingredient) by weight and a combination thereof. In at least one embodiment of these aforementioned, the naturally-collagen-rich material is a naturally occurring animal material (or a natural Animal Parts material, or a natural organ material) that inherently/naturally contains at least 50% collagen.

In some embodiments of the present disclosure, it is to provide an edible pet chew including an extruded sheet component formed of a collagen-based composition material having at least 10% meat ingredient by weight, at least 20% plant ingredient by weight and any one of: at least 50% naturally-collagen-rich material by weight, at least 30% collagen (constituent, element or ingredient) by weight and a combination thereof. In an exemplary composition (formula) embodiment of the aforementioned embodiments, the composition (formula) of the collagen-based composition is: Ground corium layer of beef skin (40%), Ground corium layer of porcine skin (15%), Corn (12%), Rice (10%), Chicken breast (12%), Glycerin (2%), Sorbitol (1%), Peanut butter (2%, plant ingredient), Fructose (1%), Barley malt syrup (1%), Pork gelatin (1%), Salt (1%), Sodium Tripolyphosphate (0.5%), Potassium sorbate (preservative) (0.2%), Sodium pyrophosphate (0.2%), Xanthan gum (0.5%), Sodium propionate (preservative) (0.2%), Artificial flavoring (0.2%), FD&C Red 40 (0.1%), FD&C Blue 1 (0.05%), FD&C Yellow 6 (0.03%), FD&C yellow 5 (0.02%). In this formula, naturally-collagen-rich ingredient totally occupies 55% (40%+15%) of the formula, plant ingredients 24% (12%+10%+2%) and meat ingredient (12%).

In some embodiments of the present disclosure, it is to provide an edible pet chew including an extruded sheet component formed of a collagen-based composition material having at least 20% plant ingredient by weight and any one of: at least 50% naturally-collagen-rich material by weight, at least 30% collagen (constituent, element, or ingredient) by weight and a combination thereof. In an exemplary formula (constitution) embodiment of the aforementioned embodiments, the formula of the collagen-based composition is: Tapioca starch (25%), Collagen (30%, extracted collagen from swine bone, classified as collagen constituent), Pig ligament (3%, classified as a source of collagen, containing 80% collagen), Beef trachea (3%, classified as a source of collagen, containing 85% collagen), wheat flour (12%), Beef (3%), Water (12%), Glycerin (11%) and beef liver (1%). In this formula, collagen constituent totally occupies over 34.95% of the formula (30%+3%*80%+3%*85%+ the collagen constituent from beef and beef liver), plant ingredients 37%, meat by-product ingredient 1%, meat 3%.

In some embodiments of the present disclosure, it is to provide an edible pet chew including an extruded sheet component formed of a collagen-based composition material, in which the edible pet chew has at least 3% UC-II collagen in the formula.

In some embodiments of the present disclosure, it is to provide a pet chew including an extruded sheet component formed of a (artificial) composition material, in which the composition includes Glucosamine constituent (or element, or ingredient) and/or Chondroitin constituent (or element, or ingredient) or a naturally-Glucosamine/Chondroitin-rich material in it.

In yet another aspect of the present disclosure, an edible pet chew is provided including an extruded (ordinary) tubular component (formed from a tubular extrudate) formed of a collagen-based composition/composition material having at least 20% (or 20%-90%) collagen-rich (naturally-collagen-rich) material by weight and/or at least 10% (or 10%-80%) collagen (constituent, element or ingredient) by weight. In some embodiments of the present disclosure, the naturally-collagen-rich material is any one of: corium (layer) part of animal skin, dermis (layer) part of animal skin, innermost layer of animal skin, inner layer of animal skin, cartilage, trachea, animal car, poultry foot, esophagus, animal pizzle, ligament, pericardium, animal tendon, eggshell membrane, and any combination thereof. Preferably, the extruded tubular component is a durable extruded tubular component. Typically, the tubular form of the extruded tubular component is not natural and is produced or created artificially by machine or equipment. Typically, the extruded tubular component is formed by a mono-extrusion, or a co-extrusion process. In the scenario that co-extrusion is applied, the extruded tubular component may have two longitudinal sections through the body that have different appearance (e.g., in different color) or are formulated differently.

Refer to FIG. 15, cross-section views of a group of exemplary “extruded tubular component” extrudates according to some embodiments of the present disclosure are displayed therein, produced by various extruder die designs. Extrudates 1500A, 1500B and 1500C are examples of “extruded tubular components” formed by mono-extrusion process, and extrudates 1500D, 1500E and 1500F, co-extrusion. Extrudate 1500D in a round cylindrical shape has a first section 1501 and a second section 1502 formed of a first material and a second one respectively, in which section 1501 and section 1502 are integrally formed attaching to each other firmly. Extrudate 1500E has a first section 1503 and a second section 1504 formed of a first material and a second one respectively. Extrudate 1500F has a first section 1505 and a second section 1506 formed of a first material and a second one respectively, inseparate, and attached to each other firmly. The thickness of material of section 1505 is inhomogeneous.

As shown in FIG. 14, a pet chew 1400 composed of an extruded tubular component in shape of hollow cylinder as an embodiment in the aforementioned aspect of the present disclosure is formed from a tubular extrudate, which is generated by extruding a food material with a mono-extrusion extruder. This item may also work as a basic component to be further manipulated (e.g., by twisting, wrapping, or stuffing) to form new pet chews in the aforementioned aspect of the present disclosure. The extruded tubular component may be formed from a composition material formulated as required or as desired.

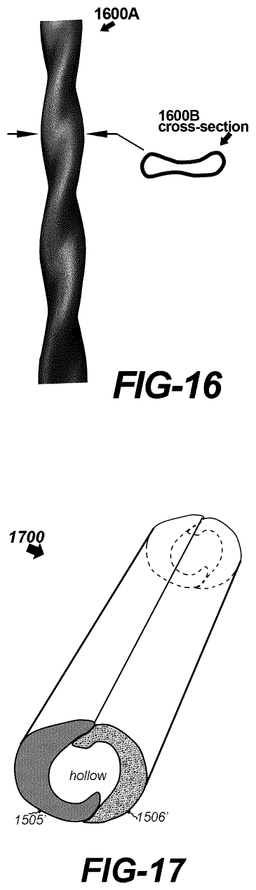

As shown in FIG. 16, a pet chew 1600A formed of an extruded tubular component in shape of twisted cylinder as an embodiment in the aforementioned aspect of the present disclosure is provided, produced by mono-extrusion extruder. Cross-section 1600B shows a view of cross-section at the particular position pointed out by the arrows.

As shown in FIG. 17, a pet chew 1700 formed of an extruded tubular component extrudate 1500F from FIG. 15 in cylindrical shape as an embodiment in the aforementioned aspect of the present disclosure is provided, having a first section 1505′ and second section 1506′ being integrally formed and attaching to each other firmly. It is produced by co-extrusion extruder.

In some embodiments of the present disclosure, an edible pet chew is provided including a collagen-based extruded (ordinary) tubular component, in which the component has an edible coating layer or basting layer on a surface of the it as an inseparable portion of it.

In some embodiments of the aforementioned aspect of the present disclosure, it is to provide an edible pet chew including an extruded tubular component formed from an extrudate, where the component is further manipulated, formed or shaped (such as knotting, wrapping, rolling, folding, braiding and twisting), optionally in conjunction with introduction of an additional edible component assembled with the extrudate component, into the shape/structure/configuration of the final end product, where the additional edible component is referred to as a second component and the extruded tubular component does as a first one.

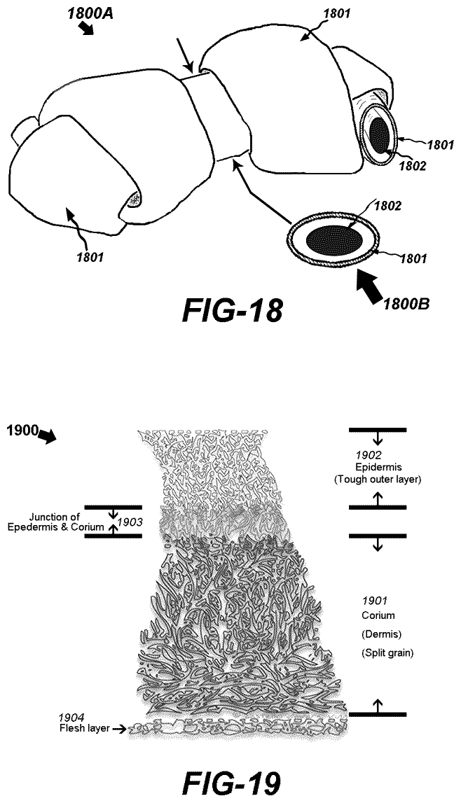

As shown in FIG. 18, a pet chew 1800A formed of an extruded tubular component in shape of knotted bone as an embodiment in the aforementioned aspect of the present disclosure is provided, produced by mono-extrusion extruder, which includes an oval-shaped cylindrical core 1802 surrounded by extruded tubular component 1801. Cross-section 1800B shows a view of cross-section at the particular position pointed out by the arrows.

### Formula

In some embodiments of the present disclosure, it is to provide an edible pet chew including an extruded tubular component formed of a collagen-based composition material having at least 20% (or 20%-90%) collagen-rich (naturally-collagen-rich) material by weight and/or at least 10% (or 10%-80%) collagen (constituent, element or ingredient) by weight, in which the pet chew as a collagen-based chew as a whole contains at least 25% collagen constituent (or element, or ingredient) in final end product counting in the collagen present in every component(s). “At least 25% collagen” in the chew may have it in accordance with the “dinners, entrees, platters, nuggets, recipe and formulas” rule under existing AAFCO labeling requirement. In some embodiments of the present disclosure, the pet chew as a collagen-based chew as a whole contains collagen constituent (or element, or ingredient) accounting for the number one constituent (or element, or ingredient) in final end product counting in the collagen present in every component(s). In some embodiments of the present disclosure, the pet chew as a collagen-based chew as a whole contains at least 50% collagen constituent (or element, or ingredient) by weight in final end product counting in the collagen present in every component(s), where collagen constituent may occupy the majority proportion in the chew.

In some embodiments of the present disclosure, it is to provide an edible pet chew including an extruded tubular component formed of a collagen-based composition material having 25%-80% (more typically 30%-80%) collagen (constituent, element, or ingredient) by weight in final product.

In some embodiments of the present disclosure, it is to provide an edible pet chew including an extruded tubular component formed of a collagen-based composition material having at least 10% meat ingredient by weight and any one of: at least 20% naturally-collagen-rich material by weight, at least 10% collagen (constituent, element, or ingredient) by weight and a combination thereof.

In some embodiments of the present disclosure, it is to provide an edible pet chew including an extruded tubular component formed of a collagen-based composition material having at least 10% meat ingredient by weight and any one of: at least 30% naturally-collagen-rich material by weight, at least 10% collagen (constituent, element, or ingredient) by weight and a combination thereof. In some embodiments of the present disclosure, it is to provide an edible pet chew including an extruded tubular component formed of a collagen-based composition material having at least 30% meat ingredient by weight and any one of: at least 30% naturally-collagen-rich material by weight, at least 10% collagen (constituent, element, or ingredient) by weight and a combination thereof.

In some embodiments of the present disclosure, it is to provide an edible pet chew including an extruded tubular component formed of a collagen-based composition material having at least 10% meat ingredient by weight, at least 20% plant ingredient by weight and any one of: at least 20% naturally-collagen-rich material by weight, at least 10% collagen (constituent, element or ingredient) by weight and a combination thereof. Alternatively, the collagen-based composition material may further have 2%-35% humectant (more typically 10%-25% humectants; humectants such as glycerin, sorbitol) ingredients.

In some embodiments of the present disclosure, it is to provide an edible pet chew including an extruded tubular component formed of a collagen-based composition material having at least 20% plant ingredient by weight and any one of: at least 20% naturally-collagen-rich material by weight, at least 10% collagen (constituent, element, or ingredient) by weight and a combination thereof. Alternatively, the collagen-based composition material may further have 2%-35% humectant (more typically 10%-25% humectants; humectants such as glycerin, sorbitol) ingredients. In at least one embodiment of the aforementioned ones, the extruded tubular component is formed of a collagen-based composition material having at least 20%-50% plant ingredient by weight and any one of: at least 50% naturally-collagen-rich material by weight, at least 25% collagen (constituent, element, or ingredient) by weight and a combination thereof.

In some embodiments of the present disclosure, it is to provide an edible pet chew including an extruded tubular component, in which the extruded tubular component is formed of a composition having 10%-30% meat ingredient and 20%-50% plant ingredient, and optionally 2%-35% humectant (more typically 10%-25% humectants; humectants such as glycerin, sorbitol) ingredients. In some embodiments of the present disclosure, it is to provide an edible pet chew including a meat-based extruded tubular component, in which the meat-based tubular component is formed of a meat-based composition having 30%-99% meat (or meat by-product, or a combination of meat and meat by-product) ingredient and 20%-50% plant ingredient, and optionally 2%-35% humectant (more typically 10%-25% humectants; humectants such as glycerin, sorbitol) ingredients.

In some embodiments of the present disclosure, it is to provide an edible pet chew including an extruded tubular component formed of a collagen-based composition material, in which the edible pet chew has at least 3% UC-II collagen in the formula.

In some embodiments of the present disclosure, it is to provide a pet chew including an extruded tubular component formed of a (artificial) composition material, in which the composition includes Glucosamine constituent (or element, or ingredient) and/or Chondroitin constituent (or element, or ingredient) or a naturally-Glucosamine/Chondroitin-rich material in it.

In some embodiments of the present disclosure, in the composition (such as a collagen-based composition, a plant-based composition, a meat-based composition and meat by-product-based composition aforementioned) of the aforementioned finned tubular component (or extruded sheet component, or extruded ordinary tubular component), the component includes a chemical in formula in addition to other ingredients. The chemical may be introduced so as to provide improved rigidity/durability and strength in final product. The chemical is selected from the group consisting of: a thickener, a humectant, a stabilizer, an emulsifier, a gelatinizer, a binder, and a filler.

The thickener is selected from the group consisting of: glucose syrup, malt syrup, soy protein Isolate, wheat protein isolate, corn protein isolate, artemisia gum, linseed gum, deacetylated chitin, pectins, sodium alginate, xanthan gum, carrageenan; phosphated distarch phosphate, sodium lactate, diacetyl tartaric acid ester of mono(di)glycerides(DATAE), sesbania gum, polyglycerol esters of fatty acid (polyglycerol monostearate, polyglycerol monooleate), maltitol, sorbitol, propylene glycol, abelmoschus manihot gum, β-cyclodextrin, arabic gum, starch acetate, guar gum, potassium alginate, carob bean gum, gellan gum, sodium polyacrylate, distarch phosphate, gelatin, hydroxypropyl, distarch phosphate, hydroxypropyl methyl cellulose, agar, acid treated starch, sodium carboxy methyl cellulose, oxidized starch and oxidized hydroxypropyl starch.

The humectant is selected from the group consisting of: soy protein Isolate, wheat protein isolate, corn protein isolate, glucose syrup, malt syrup, sodium pyrophosphate, trisodium orthophosphate, sodium hexametaphosphate, sodium tripolyphosphate, phosphoric acid, calcium dihydrogen phosphate, sodium lactate, maltitol, sorbitol, propylene glycol, glycerin, sodium dihydrogen phosphate, sodium phosphate dibasic, potassium lactate, sodium lactate, acetylated distarch phosphate and acetylated distarch adipate.

The stabilizer is selected from the group consisting of: trisodium orthophosphate, potassium sorbate, sodium stearoyl lactylate, calcium stearoyl lactylate, phosphoric acid, hydroxypropyl starch, pectins, xanthan gum, carrageenan, sodium lactate, polyglycerol esters of fatty acid (polyglycerol monostearate, polyglycerol monooleate), maltitol, sorbitol, propylene glycol, propylene glycol esters of fatty acid and glucono delta-lactone.

The emulsifier is selected from the group consisting of: soy protein Isolate, wheat protein isolate, corn protein isolate, Sucrose esters of fatty acid, sodium hexametaphosphate, sodium stearoyl lactylate, calcium stearoyl lactylate, hydroxypropyl starch, pectins, carrageenan, diacetyl tartaric acid ester of mono(di)glycerides(DATAE), polyglycerol esters of fatty acid (polyglycerol monostearate, polyglycerol monooleate), maltitol, sorbitan monolaurate, sorbitol, propylene glycol, propylene glycol esters of fatty acid, polyoxyethylene xylitan monostearate, tripolyglyceryl monostearate, potassium stearate, mono-(di-,tri-)glyce rides of fatty acids, modified soybean phospholipid, sodium caseinate, citric and fatty acid esters of glycerol, lactic and fatty acid esters of glycerol, sodium starch octenyl succinate and acetylated mono and diglyceride (acetic and fatty acid esters of glycerol).

The gelatinizer is selected from the group consisting of: soy protein Isolate, wheat protein isolate, corn protein isolate, propylene glycol, glucono delta-lactone.

The binder is selected from the group consisting of: glutinous rice flour, gelatin, linseed gum, pectins, xanthan gum, carrageenan, sesbania gum, maltitol, sodium alginate, abelmoschus manihot gum, arabic gum, guar gum, Carob bean gum, gellan gum and agar.

The filler is selected from the group consisting of: a plant material, a plant derived material, a plant protein and a plant starch, saccharide, dextrin, lactose, mineral salt, and fructose.

In another aspect of the present disclosure, in some embodiments, an edible pet chew (pet treat) includes a tubular component/member formed from a (artificial) composition material with a series of alternating (latitudinal) ridges and grooves (approximately) parallel to each other running/extending (latitudinally) on the surface, or with a Helical (spiral) ridge(s) and groove(s) (like a screw thread) running/extending helically on its surface along the body. The formula of the composition material can refer to the formula embodiments for the finned tubular component (for example, the composition material can be in a collagen-based formula) described in previous paragraph. In other words, they can be formulated identically. Refer to FIG. 21. The pet chew 2100A has a tubular composition-material Component 2120 in a corrugated-pipe shape with a series of alternating ridges (ridge examples 2101/2102/2103) and grooves (groove examples 2104/2105/2106) running/extending latitudinally on the surface. A cross-section shape 2100B of pet chew 2100A is a circle obtained at 2110. The ridges in a shape of closed-circle having rounded tops (examples of the rounded tops are 2107 and 2108) run parallel to each other. Ridge Height 2109 of ridge 2103 is about 6 mm. Groove 2104 extends latitudinally between ridge 2102 and ridge 2103, in which the depth of 2104 is substantially equal to the average heights of ridge 2102 and ridge 2103. Tops 2107 and 2108 from pet chew 2100A refer to rounded tops of the ridges.

In another aspect of the present disclosure, in some embodiments, an edible pet chew (pet treat) includes a tubular Trachea-shaped component made of a (artificial) composition material with a series of alternating (latitudinal) ridges and grooves (approximately) parallel to each other running/extending (latitudinally) on the surface. The formula of the composition material can refer to the formula embodiments for the finned tubular component (for example, the composition material can be in a collagen-based formula) described in previous paragraph. In other words, they can be formulated identically.

In an aspect of the present disclosure, in some embodiments, an edible pet chew includes a curved “corrugated sheet” or a curved “ribbed sheet” (that is curved to form a tube shape or a hollow cylindrical shape) component in a tube shape or hollow cylindrical shape made of composite/composition material. The term of “corrugated sheet” generally refers to a thin flat (sheet) material that is formed into a shape of a series of (approximately) parallel folds that may look like waves, typically whose sheet material thickness is substantially homogeneous throughout the material. For example, a material initially being a flat sheet is re-formed to take a series of parallel folds. The term “ribbed sheet” generally refers to a material in a sheet form (the sheet herein refers to the one in a broad sense as defined in a previous paragraph) having a raised pattern of (approximately) parallel lines on it. Usually, the material thickness of raised line parts of a “ribbed sheet” is significantly larger than that of the non-raised parts. It should be noted that, while referring a material is “flat” in a broad sense, it means that the material is averagely not very tall or deep in relation to its length and width and its surface does not have to be smooth, such as the “flat” from “initially-flat corrugated-sheet” and “initially-flat ribbed-sheet that may have a textured surface. It should be noted that, the term “curved” from the “curved Corrugated Sheet” object refers to a corrugated-sheet material in a shape of curve or with a smoothly bending surface. The cross-section of the “curved Corrugated Sheet” may be in a shape of a curve, such as an open curve and a closed curve. The term of “curved” from the “curved Ribbed Sheet” object refers to a ribbed-sheet material in a shape of curve or with a smoothly bending surface. The cross-section of the “curved Ribbed Sheet” may be in a shape of a curve, such as an open curve and a closed curve. The formula of the composition material can refer to the formula embodiments for the finned tubular component (for example, the composition material can be in a collagen-based formula) described in previous paragraph. In other words, they can be formulated identically. In additional, the

In another aspect of the present disclosure, in some embodiments, an edible pet chew includes a rolled “corrugated sheet” or rolled “ribbed sheet” (that is rolled up to a cylindrical form or a tubular form) component in a cylinder shape or tube shape made of composite/composition material. The formula of the composition material can refer to the formula embodiments for the finned tubular component (for example, the composition material can be in a collagen-based formula) described in previous paragraph. In other words, they can be formulated identically.

In yet another aspect of the present disclosure, in some embodiments, an edible pet chew includes an animal hide sheet tubular component (esp. an animal skin corium layer sheet tubular component made of animal skin corium layer or a rawhide free animal skin sheet tubular component made of rawhide free animal skin sheet), in which the tubular component has a series of alternating ridges and grooves (approximately) parallel to each other running/extending on the surface, or has a Helical (spiral) ridge(s) and groove(s) (like a screw thread) running/extending helically on its surface along the body. Alternatively, the animal hide sheet tubular component may be made of rawhide sheet while it is an inferior material choice.

One skilled in the art will understand that the embodiment of the present disclosure as shown in the drawings and described above is exemplary only and not intended to be limiting.

What is claimed is:

1. An edible pet chew, comprising:
a finned tubular component formed from a finned tubular extrudate, wherein said finned tubular extrudate comprises a fin and a tube body part, wherein said fin extends on a surface of said tube body part along a length of said tube body part, wherein said finned tubular component is made of a composition material, wherein said finned tubular component is formed by extrusion process,
wherein said finned tubular extrudate has an opening at each end.

2. The edible pet chew of claim 1, wherein said fin and said tube body part are integrally formed, wherein said fin is a thin piece sticking out from said tube body part,
wherein an average thickness and an average width of said fin are in a ratio less than 1:3,
wherein an extremity of the width of said fin is attached to said surface of said tube body part and the opposite extremity is free.

3. The edible pet chew of claim 2, wherein said fin is in a sheet-like form,
wherein said average thickness of said fin is in a range between 0.2 mm and 10 mm,
wherein said fin sticks out at a slant from said tube body,
wherein an overall length of said fin is substantially equal to an overall length of said tube body.

4. The edible pet chew of claim 1, wherein a cross-section outline shape of said tube body part is any one of: a closed curve, a closed circle,
wherein said cross-section outline shape is selected from the group consisting of: an oval, a rounded-triangle, a rounded-rectangle, a polygon, an Arabic “8” and an irregular shape.

5. The edible pet chew of claim 1, wherein said finned tubular component is rawhide free.

6. The edible pet chew of claim 1, wherein said finned tubular extrudate is formed by co-extrusion, wherein said fin is made of a first material, wherein said tube body part is made of a second material,
wherein said fin and said tube body part are formulated differently.

7. The edible pet chew of claim 1, wherein said composition material is a mixture, wherein said composition material is a collagen-based composition material,
wherein said collagen-based composition material comprises any one of: 20%-90% naturally-collagen-rich material by weight, 10%-80% collagen constituent by weight and a combination thereof, wherein said naturally-collagen-rich material comprise at least 50% collagen in composition,
wherein said naturally-collagen rich material is selected from a group consisting of: corium layer of animal skin, dermis layer of animal skin, corium layer of beef skin, corium layer of porcine skin, inner layer of beef skin, inner layer of porcine skin, animal cartilage, animal trachea, animal ear, poultry foot, animal esophagus, animal pizzle, animal ligament, animal pericardium, animal tendon, eggshell membrane and any combination thereof.

8. The edible pet chew of claim 7, wherein all naturally-collagen-rich material existing in said collagen-based composition material added together accounts for the number one proportion ingredient in a constitution of said collagen-based composition material by weight, and wherein said number one proportion ingredient is larger than any other individual ingredient proportion existing in the constitution of said collagen-based composition material.

9. The edible pet chew of claim 7, wherein said collagen-based composition material further comprises any one of: at least 10% meat ingredient by weight, at least 10% meat by-product ingredient by weight, at least 20% plant ingredient by weight, a chemical ingredient and a combination thereof.

10. The edible pet chew of claim 7, wherein said collagen-based composition material comprises 25%-90% naturally-collagen-rich material or 30%-90% naturally-collagen-rich material.

11. The edible pet chew of claim 7, wherein said naturally-collagen-rich material is a corium layer of animal skin material.

12. The edible pet chew of claim 7, wherein said collagen-based composition material comprises any one of: 50%-90% naturally-collagen-rich material by weight, 25%-80% collagen constituent by weight, and a combination thereof.

13. The edible pet chew of claim 1, wherein said composition material is a mixture, wherein said composition material is a meat-based composition material,
wherein said meat-based composition material comprises 20%-50% plant ingredient, a chemical ingredient and any one of: 30%-99% meat ingredient, 30%-99% meat by-product ingredient and 30%-99% meat and meat by-product combination ingredient.

14. The edible pet chew of claim 8, wherein said plant ingredient is selected from the group consisting of: potato, sweet potato, mung bean, wheat, corn, tapioca, rice, pea, soybean, peanut, almond, mushroom, legumes, beans, grains, chia seed, algae, seaweed, spirulina, cereals, a material of plant edible part, a plant derived material, a plant protein, a plant starch, a plant fiber, a vegetable material, a vegetable derived material, a vegetable protein, a vegetable starch, and any combination thereof,
wherein said meat ingredient is selected from a group consisting of: vertebrate flesh, livestock flesh, bovine flesh, porcine flesh, ovine flesh, caprine flesh, poultry flesh and fish flesh and any combination thereof,
wherein said meat by-product ingredient is selected from the group consisting of: milk, milk powder, milk-derived material, cheese, cheese-derived material, whey, whey protein powder, whey-derived material, egg, egg-derived material, eggshell membrane, animal hide, cartilage, trachea, animal ear, poultry foot, esophagus, animal pizzle, ligament, pericardium, tendon, lungs, spleen, kidneys, livers, blood, bone, partially defatted low-temperature fatty tissue, stomachs and intestines free of their contents and a combination thereof.

15. The edible pet chew of claim 1, wherein said composition material is a mixture, wherein said composition material is a plant-based composition material,
wherein said plant-based composition material comprises at least 50% plant ingredient and a chemical ingredient.

16. The edible pet chew of claim 1, which is any one of: a collagen-based chew comprising at least 25% collagen constituent by weight as a whole, and a cartilage-based chew comprising at least 25% cartilage constituent by weight as a whole.

17. The edible pet chew of claim 1, comprising:
an ingredient in the chew by weight selected from the group consisting of: at least 3% trachea material, at least 3% esophagus material, at least 3% cartilage material, at least 3% naturally cartilage-rich material, at least 3% naturally glucosamine-rich material, at least 3% naturally chondroitin-rich material, at least 0.2% synthetic glucosamine, at least 0.1% synthetic chondroitin, at least 0.2% glucosamine supplement material, at least 0.1% chondroitin supplement material, at least 0.2% glucosamine compound, at least 0.1% chondroitin compound, at least 0.2% glucosamine sulfate, at least 0.1% chondroitin sulfate, at least 0.2% glucosamine hydrochloride, at least 0.1% chondroitin hydrochloride, and any combination thereof.

18. The edible pet chew of claim 1, wherein said finned tubular component comprises a coating layer or a basting layer as a part thereof on a surface.

19. The edible pet chew of claim 1, wherein said finned tubular extrudate is manipulated into a final product shape selected from a group consisting of: twisted tube shape, knotted bone shape, tube ring shape, shape of braids, dumbbell shape, and spiral shape.

20. The edible pet chew of claim 1, further comprising a second edible material component, wherein said finned tubular component serves as a first component, wherein said first component and said second edible material component are assembled together in a pre-determined relationship to form a final product.
